(19) United States
(12) Patent Application Publication
(10) Pub. No.: US 2019/0052786 A1
(43) Pub. Date: Feb. 14, 2019

(54) MOTOR DRIVE DEVICE THAT REDUCES COLLISION NOISE OF MOVING MEMBER, METHOD OF CONTROLLING SAME, AND STORAGE MEDIUM

(71) Applicant: CANON KABUSHIKI KAISHA, Tokyo (JP)

(72) Inventors: Kaoru Suto, Hirosaki-shi (JP); Chikara Aoshima, Kawasaki-shi (JP); Nobuhisa Kojima, Yokohama-shi (JP)

(21) Appl. No.: 16/055,740

(22) Filed: Aug. 6, 2018

(30) Foreign Application Priority Data
Aug. 10, 2017 (JP) 2017-155773

(51) Int. Cl. H04N 5/232; H02P 8/14; H02K 37/14; H02K 11/215; H02P 21/06; H04N 5/225

(52) U.S. Cl. CPC H04N 5/2328; H02P 8/14; H02K 37/14; H04N 5/23299; H02P 21/06; H04N 5/2254; H02K 11/215

(57) ABSTRACT

A motor drive device that is capable of reducing collision noise generated by a mirror while maintaining a driving speed of the mirror. A control circuit of the motor drive device controls driving of a motor including magnetic sensors for detecting a rotational position of a rotor. An energization time-setting circuit of the control circuit sets an energization time period of the motor, and the control circuit controls driving of the motor depending on a detection result output from each magnetic sensor and the set energization time period.

### BACKGROUND OF THE INVENTION

### Field of the Invention

The present invention relates to a motor drive device, a method of controlling the same, and a storage medium, and more particularly to driving of a mirror equipped in a single-lens reflex camera.

### Description of the Related Art

In general, a stepping motor has the features of compactness, high torque, and a long product life, and is capable of easily performing a positioning operation by open-loop control. Therefore, the stepping motor is widely used for information home electrical appliances, such as a camera and an optical disk device, OA equipment, such as a printer and a projector, and so forth.

However, in a case where the stepping motor is rotated at a high speed and a case where the load on the motor is high, the motor sometimes steps out, and further, in a case where the rotational acceleration of a rotor undergoes a sudden change, impact vibration is caused due to the rotational inertia of the rotor. Further, the stepping motor is lower in efficiency than a brushless motor and a DC motor.

To solve these problems, there has been proposed, for example, a method of preventing step-out by attaching an encoder to the stepping motor and switching energization depending on the position of the rotor, to thereby drive the stepping motor as a brushless DC motor.

Also, there has been proposed, for example, a motor drive device that prevents, in the case of a sudden change in the rotational acceleration of the rotor, impact vibration from being caused by the rotational inertia of the rotor (see Japanese Laid-Open Patent Publication (Kokai) No. 2011-97720).

According to Japanese Laid-Open Patent Publication (Kokai) No. 2011-97720, when switching the driving of the motor from feedback control driving to open-loop control driving, the driving control of the motor is performed such that the rotational frequency and rotational (angular) acceleration controlled by the feedback driving control are made close to an initial rotational frequency and an initial rotational (angular) acceleration in the open-loop driving control.

Further, there has been proposed a motor that detects the position of a rotor using magnetic sensors, and sequentially switches energization of coils (see Japanese Laid-Open Patent Publication (Kokai) No. 2014-128143).

The motor disclosed in Japanese Laid-Open Patent Publication (Kokai) No. 2014-128143 includes a magnetic sensor arranged such that excitation timing of one coil is within a range of electrical angles of 0 degree to 45 degrees, and a magnetic sensor arranged such that excitation timing of the other coil is within a range of electrical angles of 45 to 90 degrees. With this arrangement, by setting a plurality of electrical advance angles, the motor is prevented from stepping out.

However, if the method described in Japanese Laid-Open Patent Publication (Kokai) No. 2011-97720 is applied to a mirror drive device that drives a main mirror using a motor as a drive source, there occurs the following problem: In a mechanism, for example, which brings the main mirror being rotated into abutment with a stopper while performing deceleration driving of the main mirror, and holds the main mirror at a fixed stop position while pressing a mirror mechanism against the stopper, collision noise is generated when the main mirror is brought into abutment with the stopper. Further, after the main mirror has been brought into abutment with the stopper, load on the motor is high in a pressing section during which the mirror mechanism is pressed against the stopper. For this reason, in the low-speed driving of the motor by the driving control in which energization of the motor coils is switched at predetermined time intervals, the motor is liable to step out.

Further, if the load of the main mirror changes due to the posture or position of the mirror mechanism and the temperature environment, the load on the motor increases, so that the main mirror sometimes stops before reaching a predetermined position.

Further, when the method described in Japanese Laid-Open Patent Publication (Kokai) No. 2014-128143 is applied to the above-described mechanism, to reduce collision noise generated when the main mirror is brought into abutment with the stopper, it is necessary to decelerate the motor having been subjected to high-speed driving, before reaching the stopper, to thereby bring the main mirror into abutment with the stopper at a predetermined speed.

However, the load of the main mirror changes due to the posture or position of the mirror mechanism and the temperature environment, which varies the load on the motor, and hence it is difficult to bring the main mirror into abutment with the stopper at the predetermined speed.

Further, if the main mirror is excessively decelerated, variation of the load of the main mirror due to the posture or position of the mirror mechanism and the temperature environment increases the load on the motor, so that the main mirror sometimes stops before reaching the predetermined position.

### SUMMARY OF THE INVENTION

The present invention provides a motor drive device that is capable of reducing collision noise generated by a mirror while maintaining a driving speed of the mirror, a method of controlling the same, and a storage medium.

In a first aspect of the present invention, there is provided a motor drive device that controls driving of a motor including a detection sensor for detecting a rotational position of a rotor, comprising one or more processors, wherein the processor functions as the following units according to a program stored in a memory: a setting unit configured to set an energization time period of the motor, and a control unit configured to control driving of the motor, depending on a detection result output from the detection sensor and the energization time period set by the setting unit.

In a second aspect of the present invention, there is provided a method of controlling a motor drive device that controls driving of a motor including a detection sensor for detecting a rotational position of a rotor, comprising setting an energization time period of the motor, and controlling driving of the motor, depending on a detection result output from the detection sensor and the set energization time period.

In a third aspect of the present invention, there is provided a non-transitory computer-readable storage medium storing a computer-executable program for executing a method of controlling a motor drive device that controls driving of a motor including a detection sensor for detecting a rotational position of a rotor, wherein the method comprises setting an energization time period of the motor, and controlling driving of the motor, depending on a detection result output from the detection sensor and the set energization time period.

According to the present invention, it is possible to reduce the collision noise generated by the moving member while maintaining the driving speed of the moving member, such as a mirror.

Further features of the present invention will become apparent from the following description of exemplary embodiments (with reference to the attached drawings).

### BRIEF DESCRIPTION OF THE DRAWINGS

FIG. 1 is a block diagram of a motor drive device according to a first embodiment of the present invention and a motor.

FIG. 2 is a perspective view, partly broken away, of the motor driven by the motor drive device shown in FIG. 1.

FIG. 3 is a diagram showing a relationship between the rotational angle of a rotor and the torque of the motor when predetermined electric currents are passed through coils of the motor shown in FIG. 2.

FIGS. 4A and 4B are schematic cross-sectional views of the motor taken in a direction orthogonal to an axis of the motor, showing phase relationships between yokes and a magnet of the motor.

FIGS. 5A to 51 are diagrams useful in explaining the operation of the motor.

FIGS. 6A and 6B are diagrams useful in explaining a feedback energization-switching mode of the motor drive device.

FIGS. 7A and 7B are diagrams useful in explaining energization of first and second coils, which is performed by the motor drive device.

FIG. 8A is a flowchart of a motor driving control process performed by the motor drive device shown in FIG. 1.

FIG. 8B is a continuation of FIG. 8A.

FIG. 9A is a flowchart of a motor reverse driving control process performed by the motor drive device shown in FIG. 1.

FIG. 9B is a continuation of FIG. 9A.

FIG. 10 is a block diagram of a motor drive device according to a second embodiment of the present invention and a motor.

FIG. 11 is a diagram useful in explaining energization of the first and second coils, which is performed by the motor drive device shown in FIG. 10.

FIG. 12 is a view, partly broken away, of a digital single-lens reflex camera (hereafter referred to as the camera) as an image pickup apparatus including a mirror drive device as the motor drive device according to the first or second embodiment.

FIG. 13 is a perspective view of an example of the mirror drive device used in the camera shown in FIG. 12.

FIGS. 14A and 14B are side views of the mirror drive device used in the camera shown in FIG. 12.

FIG. 15 is a diagram showing an example of a relationship between a motor rotational speed and mirror driving sections of the mirror drive device shown in FIG. 13.

FIG. 16A is a flowchart of a variation of the motor driving control process performed by the motor drive device shown in FIG. 1.

FIG. 16B is a continuation of FIG. 16A.

FIG. 17A is a flowchart of a variation of the motor reverse driving control process performed by the motor drive device shown in FIG. 1.

FIG. 17B is a continuation of FIG. 17A.

FIG. 18 is a diagram showing another example of the relationship between the motor rotational speed and the mirror driving sections of the mirror drive device shown in FIGS. 13.

### DESCRIPTION OF THE EMBODIMENTS

The present invention will now be described in detail below with reference to the accompanying drawings showing embodiments thereof.

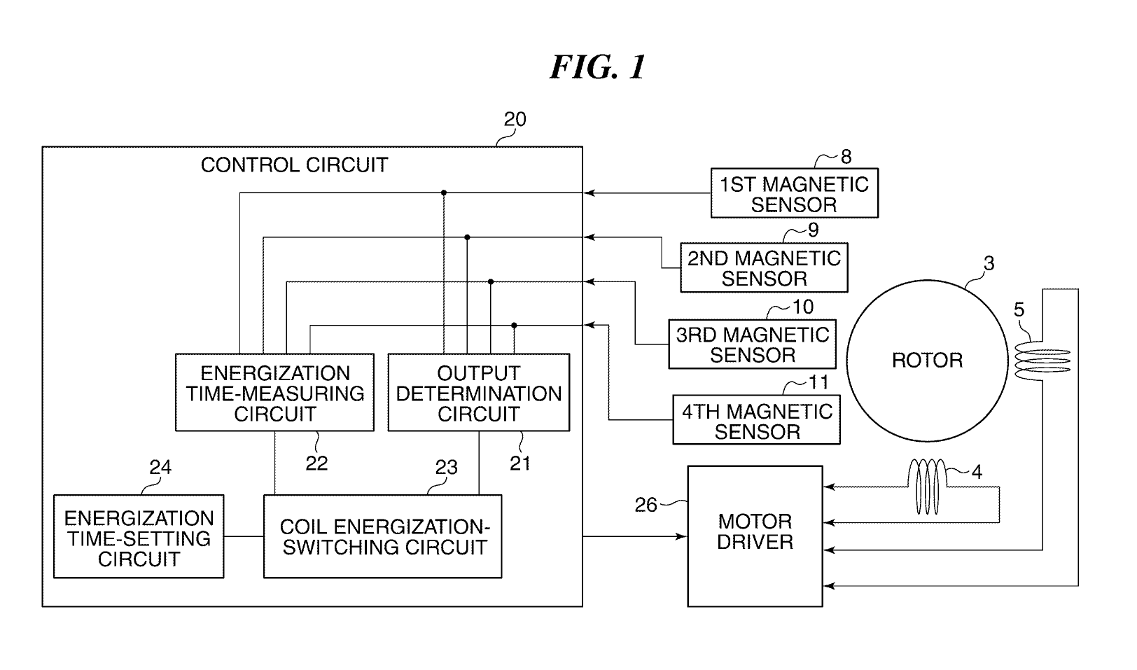

FIG. 1 is a block diagram of a motor drive device according to a first embodiment of the present invention and a motor.

The illustrated motor drive device includes a control circuit 20, and the control circuit 20 includes an output determination circuit 21, an energization time-measuring circuit 22, a coil energization-switching circuit 23, and an energization time-setting circuit 24.

As described hereinafter, the motor is provided with first to fourth magnetic sensors (detection sensors) 8 to 11, and the first to fourth magnetic sensors 8 to 11 each output a voltage according to rotation of a rotor 3. In the illustrated example, for example, Hall elements are used for the first to fourth magnetic sensors 8 to 11.

The output determination circuit 21 is connected to the first to fourth magnetic sensors 8 to 11, and determines an output state of each of the first to fourth magnetic sensors 8 to 11. The energization time-measuring circuit 22 is connected to the first to fourth magnetic sensors 8 to 11, and measures time it takes for the output state of each of the first to fourth magnetic sensors 8 to 11 to change, as an elapsed time period. The coil energization-switching circuit 23 controls switching of the energization of a first coil 4 and that of a second coil 5. The energization time-setting circuit 24 sets an energization time period for the first and second coils 4 and 5.

For example, the output determination circuit 21 determines (detects) switching of output voltage from each of the first to fourth magnetic sensors 8 to 11 between a Hi (high) level and a Lo (low) level, and sends a result of the determination (detection) to the coil energization-switching circuit 23. The energization time-measuring circuit 22 measures time it takes for the output voltage from each of the first to fourth magnetic sensors 8 to 11 to switch between the Hi level and the Lo level, and sends the time as a measured time period.

The energization time-setting circuit 24 sets a set energization time period for the coil energization-switching circuit 23. The coil energization-switching circuit 23 sends switching timing commands for switching drive voltages applied to the first and second coils 4 and 5, to a motor driver 26, each based on a result of the determination performed by the output determination circuit 21, the measured time period by the energization time-measuring circuit 22, and the set energization time period. With this, driving of the motor is controlled as described hereinafter.

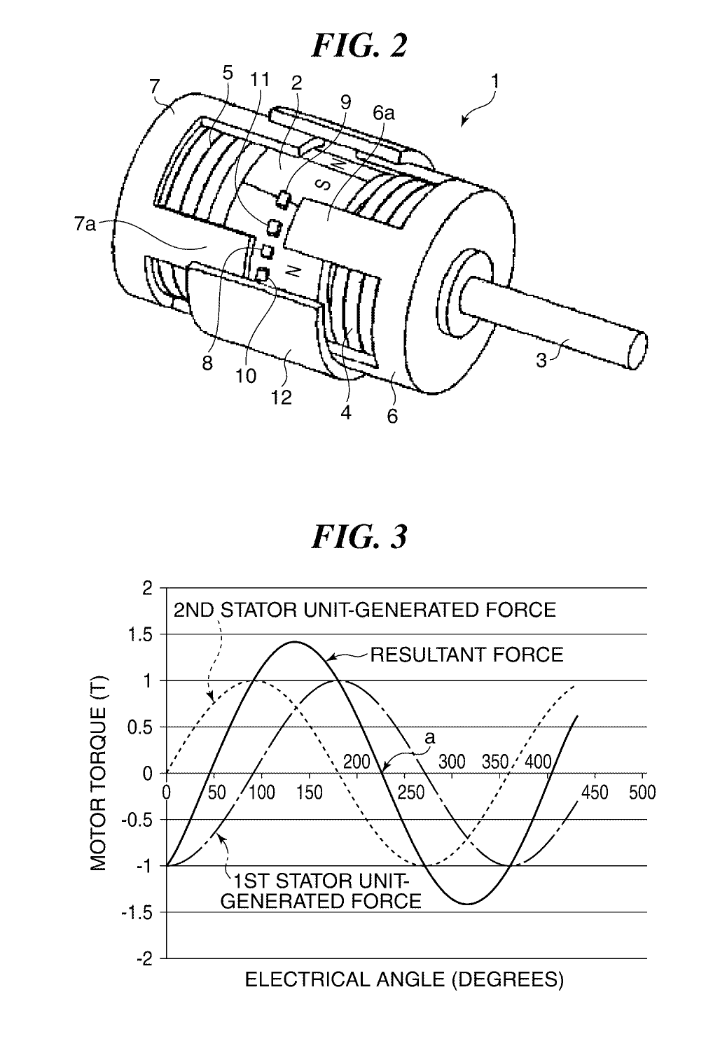

FIG. 2 is a perspective view, partly broken away, of an example of the motor driven by the motor drive device shown in FIG. 1.

A magnet 2 is mounted on the rotor 3. The magnet 2 is formed into a cylindrical shape, and is circumferentially divided into sections each with an outer periphery, each section having a different polarity from adjacent sections, thereby forming a multi-polar magnet. In the illustrated example, the magnet 2 is divided into eight sections, i.e. magnetized to eight poles. Note that the number of magnetic poles is not limited to eight, but the magnet 2 may be magnetized to four poles or twelve poles.

The first coil 4 is arranged at one end of the magnet 2 in an axial direction. A first yoke 6, which is formed of a soft magnetic material, is opposed to the outer peripheral surface of the magnet 2 with a predetermined gap. Further, the first yoke 6 has a plurality of first magnetic pole portions 6a which are axially extended from an annular main body portion and are circumferentially arranged at predetermined space intervals. The first magnetic pole portions 6a are excited by energizing the first coil 4. The first coil 4, the first yoke 6, and the magnet 2 opposed to the plurality of first magnetic pole portions 6a, form a first stator unit.

The second coil 5 is arranged at the other end of the magnet 2, which is axially opposite from the one end where the first coil 4 is arranged. A second yoke 7 is formed of a soft magnetic material, similarly to the first yoke 6, and is opposed to the outer peripheral surface of the magnet 2 with a predetermined gap. Further, the second yoke 7 has a plurality of second magnetic pole portions 7a which are axially extended from an annular main body portion, and are circumferentially arranged at predetermined space intervals. The second magnetic pole portions 7a are excited by energizing the second coil 5. The second coil 5, the second yoke 7, and the magnet 2 opposed to the plurality of second magnetic pole portions 7a, form a second stator unit.

In the illustrated motor, denoted by reference numeral 1, by switching the polarities (N pole and S pole) to which the first magnetic pole portions 6a and the second magnetic pole portions 7a are excited, it is possible to change torque applied to the rotor 3.

The Hall elements are used for the first to fourth magnetic sensors 8 to 11 as mentioned above, and the first to fourth magnetic sensors 8 to 11 each detect a magnetic flux of the magnet 2. Note that each of the first to fourth magnetic sensors 8 to 11 is fixed to a motor cover 12.

The motor cover 12 fixedly holds the first and second yokes 6 and 7 such that the first magnetic pole portions 6a and the second magnetic pole portions 7a are each arranged in a state displaced from the magnetization phase of the magnet 2 by an electrical angle of approximately 90 degrees.

The electrical angle as used herein means an angle expressed by using one period of the magnetic force of the magnet 2 which is 360 degrees. Assuming that the number of poles of the rotor 3 is represented by M, and a mechanical angle is represented by θ0, the electrical angle θ can be expressed by the following equation (1):

θ=θ0×M/2 (1)

In the illustrated example, since the number of poles magnetized in this embodiment is eight, an electrical angle of 90 degrees is equal to a mechanical angle of 22.5 degrees. The operation of feedback energization switching control will be described below using electrical angles.

FIG. 3 is a diagram showing a relationship between the rotational angle of the rotor 3 and the torque of the motor 1 when predetermined electric currents are passed through the coils of the motor 1 shown in FIG. 2.

Referring to FIG. 3, the horizontal axis represents an electrical angle (degrees), and the vertical axis represents torque (T) of the motor 1. In this graph, torque generated when the rotor 3 is rotated in a clockwise direction is defined as positive. Further, FIG. 3 shows changes in torque generated by the first stator unit (first stator unit-generated force) and torque generated by the second stator unit (second stator unit-generated force). Further, FIG. 3 shows changes in resultant force formed by combining the first stator unit-generated force and the second stator unit-generated force.

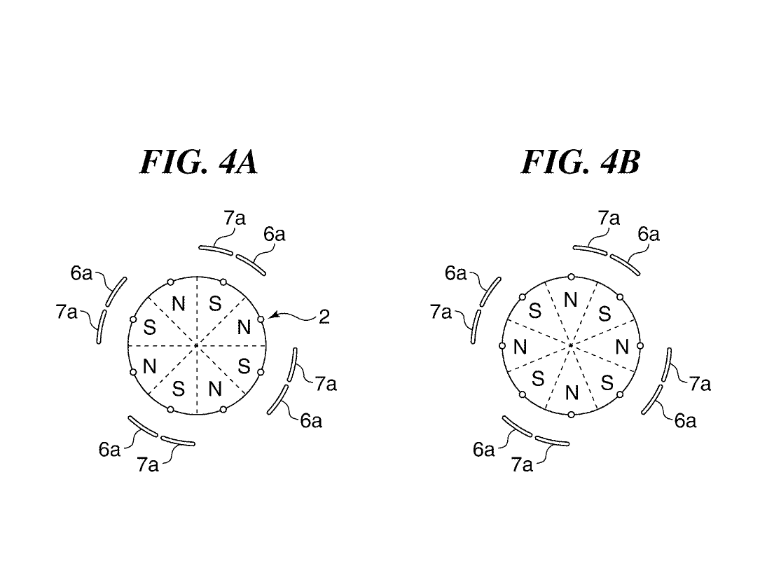

FIGS. 4A and 4B are schematic cross-sectional views of the motor 1 taken in a direction orthogonal to the axis of the motor 1, showing phase relationships between the yokes 6 and 7 and the magnet 2. FIG. 4A shows a first phase relationship, and FIG. 4B shows a second phase relationship.

Now, it is assumed that an electric current passed through the first coil 4 in the positive direction causes the first magnetic pole portions 6a to be magnetized to the N pole, and an electric current passed through the second coil 5 in the positive direction causes the second magnetic pole portions 7a to be magnetized to the N pole.

FIG. 4A shows the phase relationship (first phase relationship) in a case where a distance between the center of a magnetic pole of the magnet 2 and an associated one of the first magnetic pole portions 6a, which is opposed to the magnetic pole, and a distance between the center of the magnetic pole of the magnet 2 and an associated one of the second magnetic pole portions 7a, which is opposed to the magnetic pole, are equal to each other. Further, the phase relationship shown in FIG. 4A is indicated by a symbol “a” in FIG. 3.

Referring to the phase relationship shown in FIG. 4A, although a force for holding the rotational phase is generated, the S poles of the magnet 2 are attracted to the first magnetic pole portions 6a and the second magnetic pole portions 7a, and the magnetic forces are in a balanced state, so that a rotational driving force is not generated.

When the energization of the second magnetic pole portions 7a is switched from the phase relationship shown in FIG. 4A such that they are excited to the S pole, the rotor 3 is rotated to a position indicated by the phase relationship (second phase relationship) shown in FIG. 4B.

Referring to FIG. 4B, similar to the phase relationship shown in FIG. 4A, although a force for holding the rotational phase is generated, a rotational driving force is not generated. That is, the S poles of the magnet 2 are attracted by the first magnetic pole portions 6a, and the N poles of the magnet 2 are attracted by the second magnetic pole portions 7a, whereby the magnetic forces are in a balanced state.

The rotor 3A can be caused to be continuously rotated by alternately switching the energization directions of the first coil 4 and the second coil 5 to switch the polarities of the first magnetic pole portions 6a and the second magnetic pole portions 7a.

Switching of the polarities to which the first magnetic pole portions 6a and the second magnetic pole portions 7a are excited, by switching the energization directions of the first coil 4 and the second coil 5 in the above-described timing that the rotational driving force is not generated, is referred to as “excitation switching with an electrical advance angle of 0 degrees”. Note that switching of the polarities to which the first magnetic pole portions 6a and the second magnetic pole portions 7a are excited, by witching the energization directions of the first coil 4 and the second coil 5 at an earlier timing than the above-mentioned timing, is referred to as “excitation switching with an electrical advance angle of γ degrees.

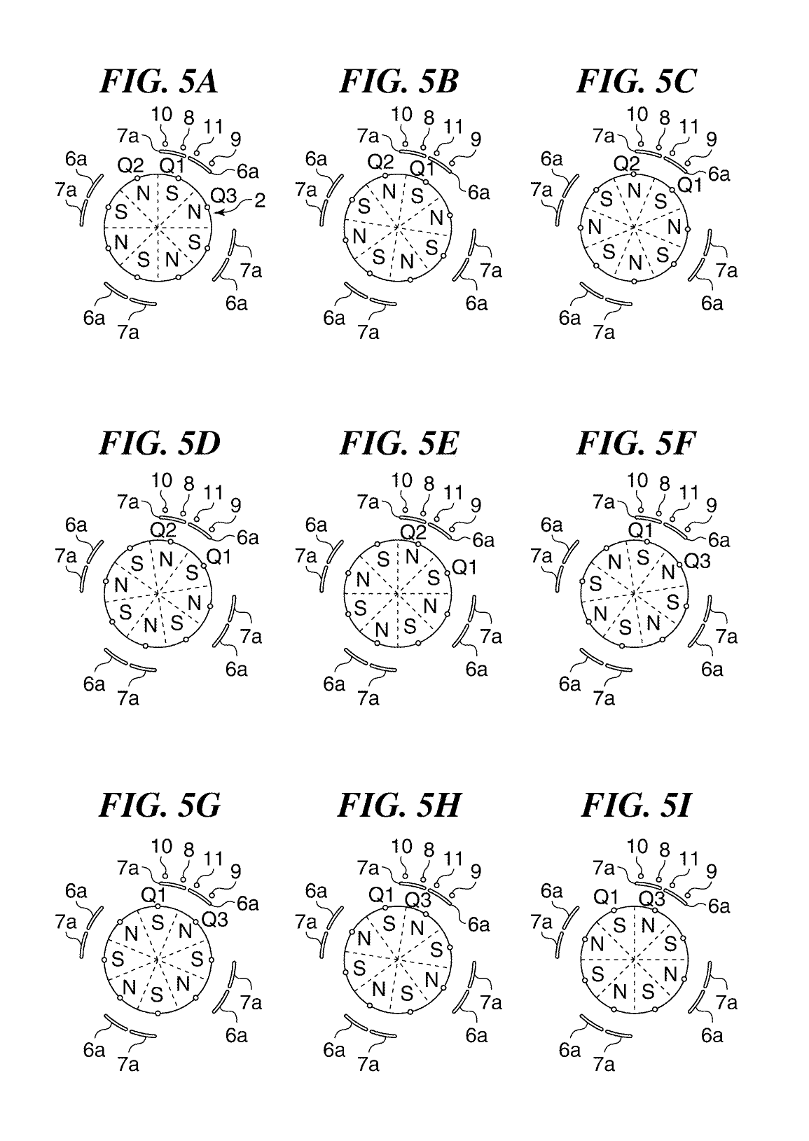

FIGS. 5A to 5I are diagrams useful in explaining the operation of the motor shown in FIG. 2. FIGS. 5A to 5I are cross-sectional views of the motor 1 taken in a direction orthogonal to the axis of the motor, showing phase relationships between the first magnetic pole portions 6a and the second magnetic pole portions 7a, the magnetic sensors 8 to 11, and the magnet 2. Note that the state shown in FIG. 5A is the initial state.

First, rotation in the clockwise direction (normal rotation) will be described. Here, excitation of the first magnetic pole portions 6a is switched depending on a detection signal output from the first magnetic sensor 8. Further, excitation of the second magnetic pole portions 7a is switched depending on a detection signal output from the second magnetic sensor 9. The operation for rotating the rotor 3 in the clockwise direction by the above-mentioned excitation switching (first energization mode) will be described. Note that the direction of rotation of the rotor 3 in the clockwise direction is defined as a first rotational direction.

In this operation, the energization direction is switched depending on the following combination of conditions of relevant elements.

When the first magnetic sensor 8 detects the S pole of the magnet 2, the first magnetic pole portions 6a are excited to the N pole, and when the first magnetic sensor 8 detects the N pole of the magnet 2, the first magnetic pole portions 6a are excited to the S pole.

When the second magnetic sensor 9 detects the S pole of the magnet 2, the second magnetic pole portions 7a are excited to the S pole, and when the second magnetic sensor 9 detects the N pole of the magnet 2, the second magnetic pole portions 7a are excited to the N pole.

In the state shown in FIG. 5A, the first magnetic sensor 8 and the second magnetic sensor 9 both detect the S pole of the magnet 2. Therefore, the first magnetic pole portions 6a are excited to the N pole, and the second magnetic pole portions 7a are excited to the S pole, and hence the rotational force in the clockwise direction is generated on the rotor 3 and the magnet 2.

When the rotor 3 is rotated in the clockwise direction from the state shown in FIG. 5A, as shown in FIG. 5B, the centers Q1 of the S poles of the magnet 2 and the centers of the first magnetic pole portions 6a are opposed to each other, respectively.

When the rotor 3 is rotated in the clockwise direction from the state shown in FIG. 5B, as shown in FIG. 5C, a distance between the center Q1 of each S pole of the magnet 2 and the center of the opposed one of the first magnetic pole portions 6a becomes equal to a distance between the center Q2 of each pole which is magnetized to a different pole (N pole) from the pole of the center Q1 and the center of the opposed one of the second magnetic pole portions 7a.

The first magnetic sensor 8 is arranged such that when switching the polarity to which the first magnetic pole portions 6a are excited based on an output from the first magnetic sensor 8, the timing of excitation switching of the first magnetic pole portions 6a relative to the rotational position of the rotor 3 is within a range of electrical angles of 0 to 45 degrees. Therefore, the first magnetic sensor 8 detects the N pole of the magnet 2 during rotation of the rotor 3 from the state shown in FIG. 5B to the state shown in FIG. 5C. At this time, the first coil 4 is energized such that the first magnetic pole portions 6a are excited to the S pole.

Further, since the second magnetic sensor 9 has detected the S pole of the magnet 2, the second coil 5 is energized such that the second magnetic pole portions 7a are excited to the S pole. As a result, the rotational force in the clockwise direction is generated on the rotor 3 and the magnet 2.

When the rotor 3 is rotated in the clockwise direction from the state shown in FIG. 5C, as shown in FIG. 5D, the centers Q2 of the N poles of the magnet 2 and the centers of the second magnetic pole portions 7a are opposed to each other, respectively.

When the rotor 3 is rotated in the clockwise direction from the state shown in FIG. 5D, as shown in FIG. 5E, a distance between the center Q2 of each N pole of the magnet 2 and the center of the opposed one of the first magnetic pole portions 6a becomes equal to a distance between the center Q2 and the center of the opposed one of the second magnetic pole portions 7a.

The second magnetic sensor 9 is arranged such that when switching the polarity to which the second magnetic pole portions 7a are excited based on an output from the second magnetic sensor 9, the timing of excitation switching of the second magnetic pole portions 7a relative to the rotational position of the rotor 3 is within a range of electrical angles of 0 to 45 degrees. Therefore, the second magnetic sensor 9 detects the N pole of the magnet 2 during rotation of the rotor 3 from the state shown in FIG. 5D to the state shown in FIG. 5E. At this time, the second coil 5 is energized such that the second magnetic pole portions 7a are excited to the N pole.

Further, since the first magnetic sensor 8 has detected the N pole of the magnet 2, the first coil 4 is energized such that the first magnetic pole portions 6a are excited to the S pole. As a result, the rotational force in the clockwise direction is generated on the rotor 3 and the magnet 2.

As described above, the energization is sequentially switched, whereby the rotor 3 and the magnet 2 are rotated in the clockwise direction.

As described above, the first magnetic sensor 8 is arranged such that when switching the polarity to which the first magnetic pole portions 6a are excited based on the output from the first magnetic sensor 8, the timing of excitation switching of the first magnetic pole portions 6a relative to the rotational position of the rotor 3 is within the range of electrical angles of 0 to 45 degrees. Further, the second magnetic sensor 9 is arranged such that when switching the polarity to which the second magnetic pole portions 7a are excited based on the output from the second magnetic sensor 9, the timing of excitation switching of the second magnetic pole portions 7a relative to the rotational position of the rotor 3 is within the range of electrical angles of 0 to 45 degrees. Therefore, even when the coil energization direction is switched depending on the output from each magnetic sensor, there is little difference in phase from a state in which the excited state is held without switching the coil energization direction.

Therefore, there is no significant difference in the phase of the rotor 3 and the magnet 2 between a case where the motor is driven by the normal stepping driving and a case where the motor is driven by switching the coil energization direction depending on the output from each magnetic sensor. As a result, even when the driving of the motor is switched between the stepping driving and the brushless driving for feedback-controlling the output from each magnetic sensor, it is possible to perform a smooth switching operation without generating vibration and oscillation. Particularly, in a case where the driving is started from the stopped state and a case where the driving is changed from the driving state to the stopped state, it is desirable to control the driving based on the above-mentioned range of electrical angles.

Next, rotation in the counterclockwise direction (reverse rotation) will be described. Here, excitation of the first magnetic pole portions 6a is switched depending on a detection signal output from the third magnetic sensor 10. Further, excitation of the second magnetic pole portions 7a is switched depending on a detection signal output from the fourth magnetic sensor 11. The operation for rotating the rotor 3 in the counterclockwise direction by the above-mentioned excitation switching (second energization mode) will be described. Note that the direction of rotation of the rotor 3 in the counterclockwise direction is defined as a second rotational direction.

In this operation, the energization direction is switched depending on the following combination of conditions of relevant elements.

When the third magnetic sensor 10 detects the S pole of the magnet 2, the first magnetic pole portions 6a are excited to the S pole, and when the third magnetic sensor 10 detects the N pole of the magnet 2, the first magnetic pole portions 6a are excited to the N pole.

When the fourth magnetic sensor 11 detects the S pole of the magnet 2, the second magnetic pole portions 7a are excited to the N pole, and when the fourth magnetic sensor 11 detects the N pole of the magnet 2, the second magnetic pole portions 7a are excited to the S pole.

In the state shown in FIG. 5A, the third magnetic sensor 10 and the fourth magnetic sensor 11 both detect the S pole of the magnet 2. Therefore, the first magnetic pole portions 6a are excited to the S pole, and the second magnetic pole portions 7a are excited to the N pole, and hence the rotational force in the counterclockwise direction is generated on the rotor 3 and the magnet 2.

When the rotor 3 is rotated in the counterclockwise direction from the state shown in FIG. 5A, as shown in FIG. 5F, the centers Q1 of the S poles of the magnet 2 and the centers of the second magnetic pole portions 7a are opposed to each other, respectively.

The third magnetic sensor 10 is arranged such that when switching the polarity to which the first magnetic pole portions 6a are excited based on an output from the third magnetic sensor 10, the timing of excitation switching of the first magnetic pole portions 6a relative to the rotational position of the rotor 3 is within a range of electrical angles of 0 to 45 degrees.

Further, the fourth magnetic sensor 11 is arranged such that when switching the polarity to which the second magnetic pole portions 7a are excited based on an output from the fourth magnetic sensor 11, the timing of excitation switching of the second magnetic pole portions 7a relative to the rotational position of the rotor 3 is within a range of electrical angles of 0 to 45 degrees.

Therefore, the fourth magnetic sensor 11 detects the N pole of the magnet 2 during rotation of the rotor 3 from the state shown in FIG. 5F to a state shown in FIG. 5G. At this time, the second coil 5 is energized such that the second magnetic pole portions 7a are excited to the S pole. Further, since the third magnetic sensor 10 has detected the S pole of the magnet 2, the first coil 4 is energized such that the first magnetic pole portions 6a are excited to the S pole. As a result, the rotational force in the counterclockwise direction is generated on the rotor 3 and the magnet 2.

When the rotor 3 is rotated in the counterclockwise direction from the state shown in FIG. 5G, as shown in FIG. 5H, the centers Q3 of the N poles of the magnet 2 and the centers of the first magnetic pole portions 6a are opposed to each other, respectively. When the rotor 3 is rotated in the counterclockwise direction from the state shown in FIG. 5H, as shown in FIG. 5I, a distance between the center Q3 of each N pole of the magnet 2 and the center of the opposed one of the first magnetic pole portions 6a becomes equal to a distance between the center Q3 and the center of the opposed one of the second magnetic pole portions 7a.

Therefore, the third magnetic sensor 10 detects the N pole of the magnet 2 during rotation of the rotor 3 from the state shown in FIG. 5H to the state shown in FIG. 5I. At this time, the first coil 4 is energized such that the first magnetic pole portions 6a are excited to the N pole.

Further, since the fourth magnetic sensor 11 has detected the N pole of the magnet 2, the second coil 5 is energized such that the second magnetic pole portions 7a are excited to the S pole. As a result, the rotational force in the counterclockwise direction is generated on the rotor 3 and the magnet 2.

As described above, the energization is sequentially switched, whereby the rotor 3 and the magnet 2 are rotated in the counterclockwise direction.

Since the third and fourth magnetic sensors 10 and 11 are arranged as described above, there is no significant difference in the phase of the rotor 3 and the magnet 2 between the case where the motor is driven by the normal stepping driving and the case where the motor is driven by switching the coil energization direction depending on the output from each magnetic sensor. As a result, even when the driving of the motor is switched between the stepping driving and the brushless driving for feedback-controlling the output from each magnetic sensor, it is possible to perform a smooth switching operation without generating vibration and oscillation. Particularly, in a case where the driving is started from the stopped state and a case where the driving is changed from the driving state to the stopped state, it is desirable to control the driving based on the above-mentioned range of electrical angles.

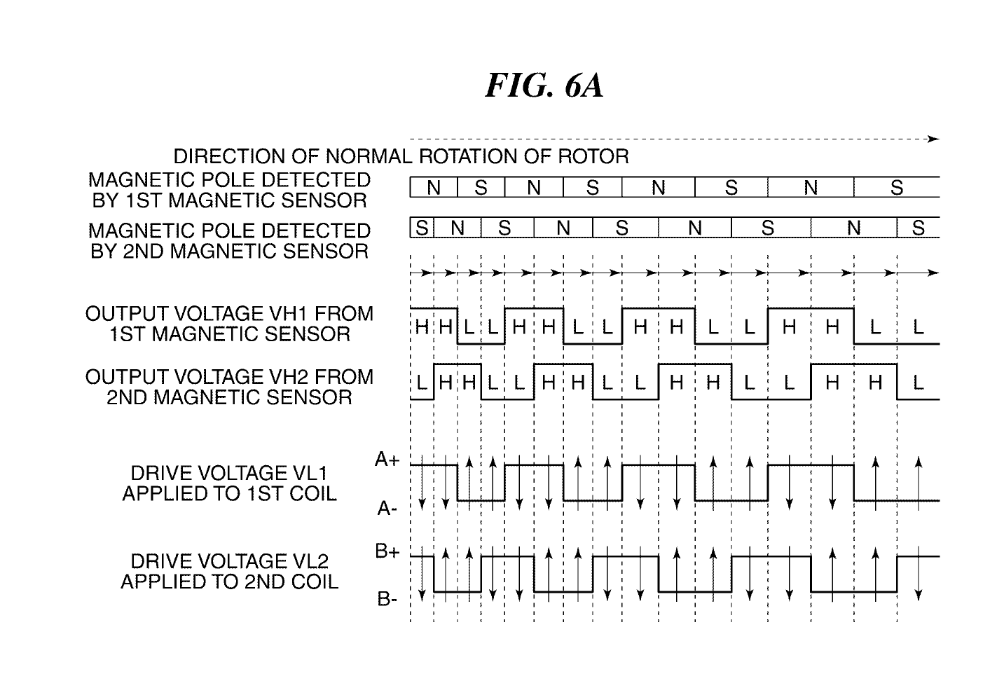

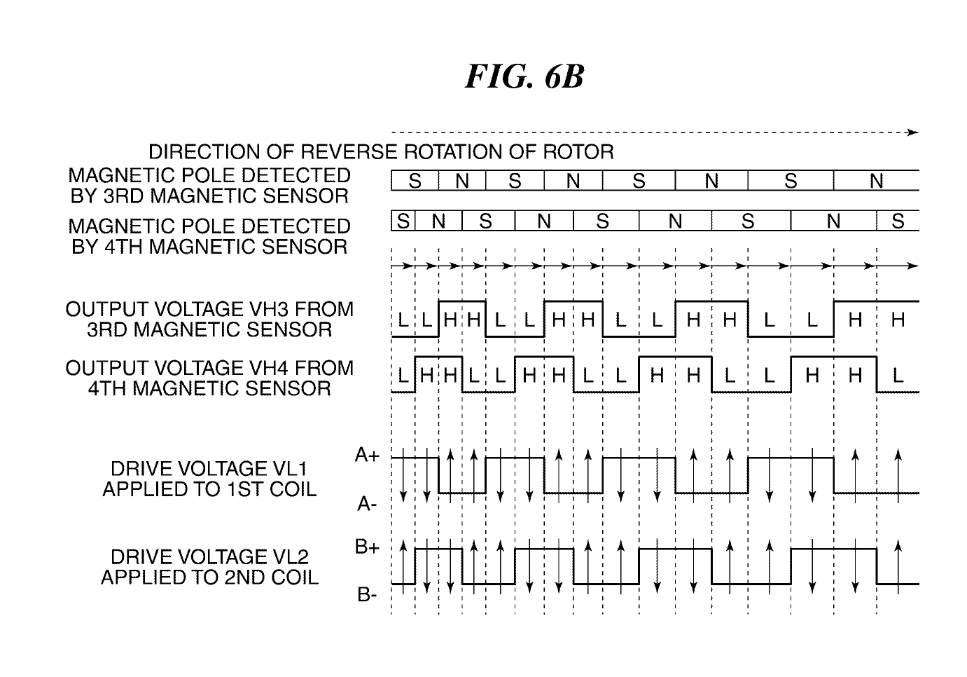

FIGS. 6A and 6B are diagrams useful in explaining a feedback energization-switching mode of the motor drive device shown in FIG. 1. FIG. 6A is a timing diagram of the operation for normally rotating the rotor, and FIG. 6B is a timing diagram of the operation for reversely rotating the rotor.

FIG. 6A shows a state of rotation of the motor in a normal rotational direction in a case where the motor is decelerated. Now, voltages output from the first magnetic sensor 8 and the second magnetic sensor 9 are denoted by VH1 and VH2, respectively. As described hereinabove, when the magnetic poles of the magnet 2, which are detected by the first magnetic sensor 8 and the second magnetic sensor 9, change, the output voltages VH1 and VH2 switch from the high (H) level to the low (L) level, or from the L level to the H level, as shown in FIG. 6A.

The coil energization-switching circuit 23 switches the energization directions of the first and second coils 4 and 5 based on the output voltages VH1 and VH2. That is, the coil energization-switching circuit 23 switches the drive voltages VL1 and VL2 applied to the first and second coils 4 and 5, as shown in FIG. 6A. With this control, the rotor 3 is rotated as shown in FIGS. 5A to 5E.

Note that in FIG. 6A, arrows illustrated on the drive voltages VL1 and VL2 each represent a direction of electric current flowing between coil terminals. Further, A+ and A−, and B+ and B− represent the winding start and the winding end of the first and second coils 4 and 5, respectively.

As shown in FIG. 6A, when the S pole of the magnet 2 is detected by the first magnetic sensor 8 and the S pole of the magnet 2 is detected by the second magnetic sensor 9, the output voltages VH1 and VH2 both become the L level.

When the output voltages VH1 and VH2 both become the L level, the coil energization-switching circuit 23 applies the drive voltage VL1 to the first coil 4 so as to cause electric current to flow therethrough in a direction from A− to A+, and applies the drive voltage VL2 to the second coil 5 so as to cause electric current to flow therethrough in a direction from B+ to B−. By doing this, the first magnetic pole portions 6a are excited to the N pole, and the second magnetic pole portions 7a are excited to the S pole. As a result, the rotational force in the clockwise direction is generated on the rotor 3 and the magnet 2.

FIG. 6B shows a state of rotation of the motor in a reverse rotational direction in a case where the motor is decelerated. Now, voltages output from the third magnetic sensor 10 and the fourth magnetic sensor 11 are denoted by VH3 and VH4, respectively. As described hereinabove, when the magnetic poles of the magnet 2, which are detected by the third magnetic sensor 10 and the fourth magnetic sensor 10, change, the output voltages VH3 and VH4 switch from the high (H) level to the low (L) level, or from the L level to the H level, as shown in FIG. 6B.

The coil energization-switching circuit 23 switches the energization directions of the first and second coils 4 and 5 based on the output voltages VH3 and VH4. That is, as shown in FIG. 6B, the coil energization-switching circuit 23 switches the drive voltages VL1 and VL2 applied to the first and second coils 4 and 5. With this control, the rotor 3 is rotated as shown in FIGS. 5A, and 5F to 5I.

As shown in FIG. 6B, when the S pole of the magnet 2 is detected by the third magnetic sensor 10 and the S pole of the magnet 2 is detected by the fourth magnetic sensor 11, the output voltages VH3 and VH4 both become the L level.

When the output voltages VH3 and VH4 both become the L level, the coil energization-switching circuit 23 applies the drive voltage VL1 to the first coil 4 so as to cause electric current to flow therethrough in a direction from A+ to A−, and applies the drive voltage VL2 to the second coil 5 so as to cause electric current to flow therethrough in a direction from B− to B+. By doing this, the first magnetic pole portions 6a are excited to the S pole, and the second magnetic pole portions 7a are excited to the N pole. As a result, the rotational force in the counterclockwise direction is generated on the rotor 3 and the magnet 2.

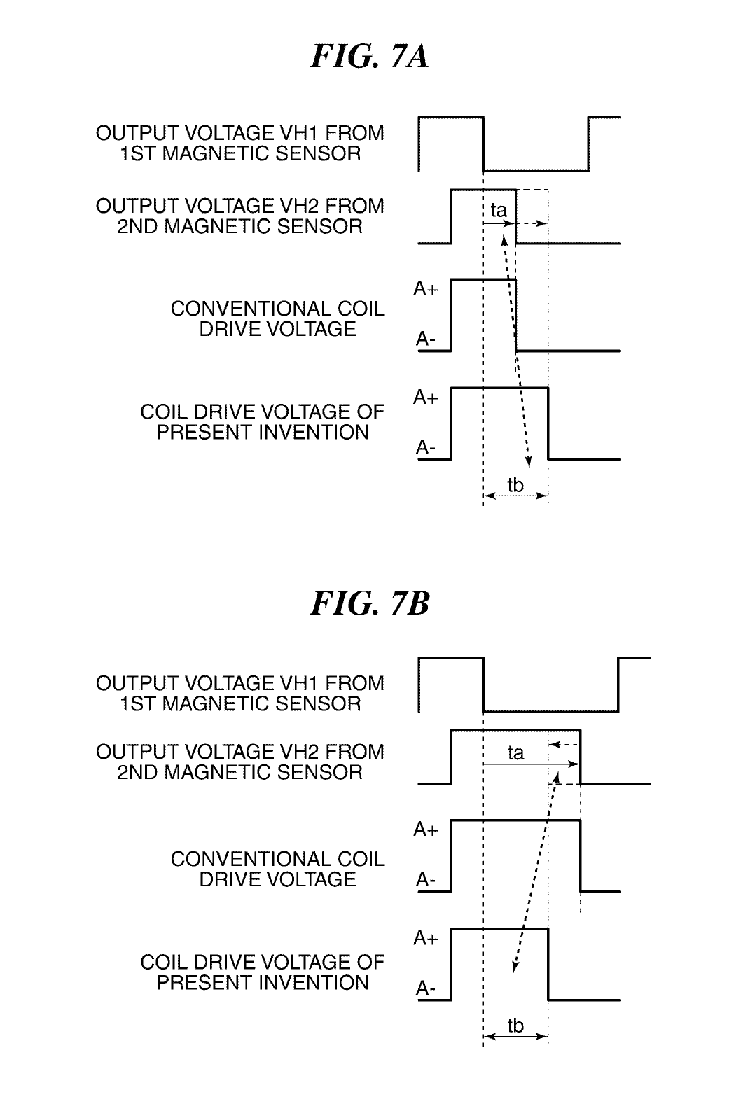

FIGS. 7A and 7B are diagrams useful in explaining energization of the first and second coils, performed by the motor drive device shown in FIG. 1. FIG. 7A shows an example of energization of the coils, and FIG. 7B shows another example.

Conventionally, when driving the motor, the driving control is performed based on the output voltages VH1 and VH2 such that the coil drive voltage is switched at timing at which each of the output voltages VH1 and VH2 switches alternately between the H level and the L level.

For example, the above-mentioned timing of switching between the H level and the L level changes due to load variation caused e.g. by a change of the posture of the camera or a change in environmental temperature. Because of this, the switching timing of the coil drive voltages is also changed, and hence the driving control described above is liable to cause rotation fluctuation of the motor.

Now, a time period from a time of switching of the output voltage VH1 to a time of switching of the output voltage VH2 is represented by ta. On the other hand, a time period from the time of switching of the output voltage VH1 to a predetermined time of supply of the coil drive voltage, which is set in advance, is represented by tb. The time period tb is the aforementioned set energization time period set for the coil energization-switching circuit 23 by the energization time-setting circuit 24.

In the driving control according to the present embodiment, at a time point at which the time period tb elapses, the coil energization-switching circuit 23 switches the direction of application of the coil drive voltage. Further, in a case where ta<tb holds, the coil energization-switching circuit 23 does not switch the direction of application of the coil drive voltage during the time period, i.e. from the lapse of ta to the lapse of tb. That is, in the case of ta<tb, deceleration driving of the motor 1 is performed. On the other hand, in a case where ta>tb holds, the coil energization-switching circuit 23 switches the direction of application of the coil drive voltage at a time point at which the time period tb elapses, which is shorter than the time period ta before the output voltage VH2 switches. That is, acceleration driving of the motor 1 is performed in the case of ta>tb.

The above-described driving control is speed control for controlling the coil energization based on a predetermined time period for each moving distance (on a step basis; i.e. based on each switching of output voltages from the magnetic sensors) while detecting the position of the rotor 3. For example, by continuously setting the predetermined time period, it is possible to cause the motor to rotate at a constant speed, and reduce rotation fluctuation against load variation. Further, by switching the coil energization in synchronism with detection of the position of the rotor 3, it is possible to prevent step-out of the stepping motor, which is a problem specific to the stepping motor.

Note that the coil energization may be switched by setting a time period from the rise to the fall of the output voltage VH2 as ta.

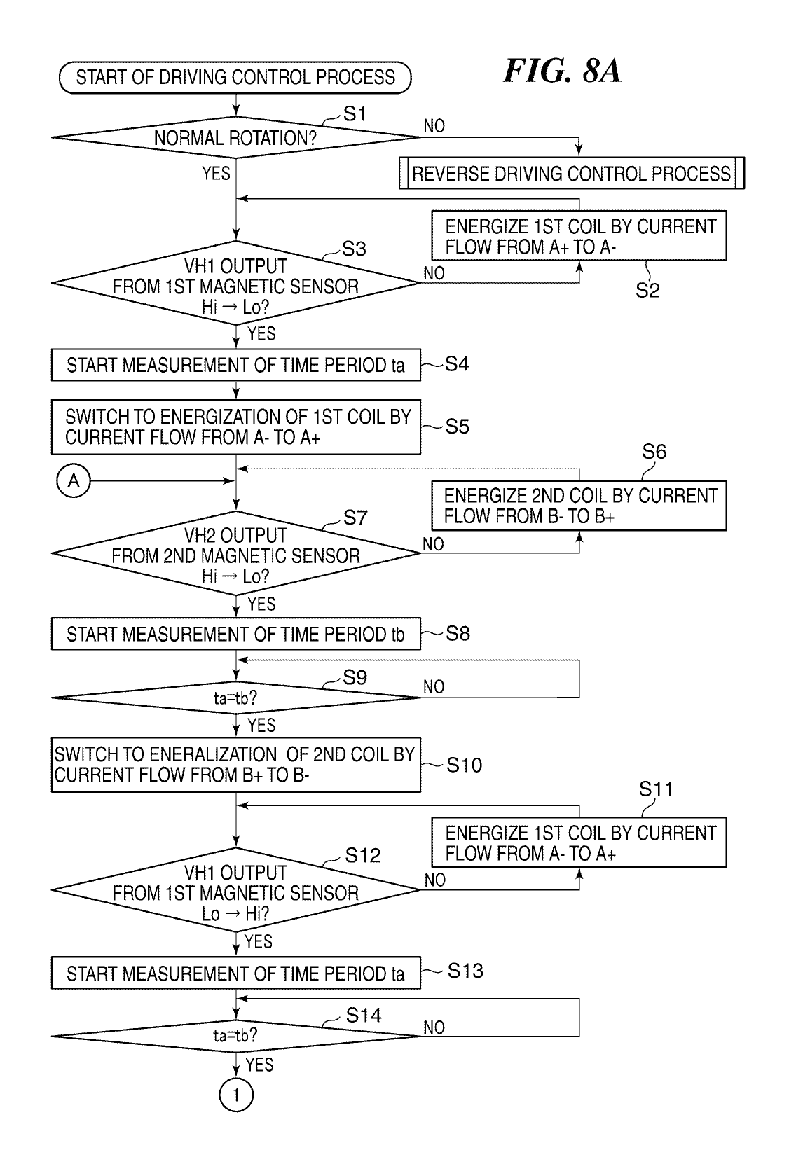

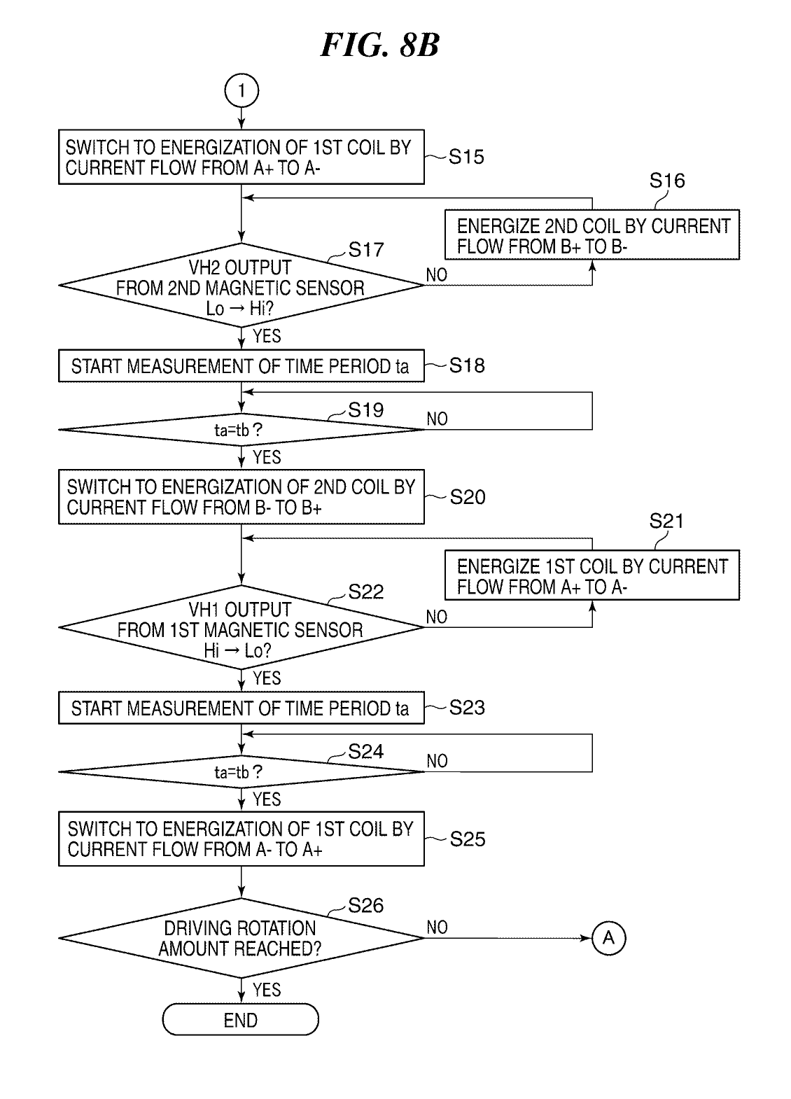

FIGS. 8A and 8B are a flowchart of a motor driving control process performed by the motor drive device shown in FIG. 1.

Now, let it be assumed that the driving rotation amount of the motor 1 is set to N (N is a positive integer). The control circuit 20 determines whether or not the normal rotation is selected as the rotational direction of the motor 1, i.e. of the rotor 3 (step S1). If the reverse rotation (counterclockwise direction as viewed from the rotor 3) is selected (NO to the step S1), the control circuit 20 performs a motor reverse driving control process, described hereinafter.

On the other hand, if the normal rotation (clockwise direction) is selected (YES to the step Si), the control circuit 20 determines whether or not the voltage VH1 output from the first magnetic sensor 8 has switched from the H (Hi) level to the L (Lo) level (step S3).

If the output voltage VH1 has not switched from Hi to Lo (NO to the step S3), the control circuit 20 continues to apply the drive voltage to the first coil 4 so as to cause electric current to flow therethrough in the direction from A+ to A− (step S2). Then, the control circuit 20 returns to the step S3.

If the output voltage VH1 has switched from Hi to Lo (YES to the step S3), the control circuit 20 starts to measure the time period ta from the switching of the output voltage VH1 to the switching of the output voltage VH2 (step S4). Then, the control circuit 20 switches the direction of application of the drive voltage VL1 to the first coil 4 (the energization direction of the first coil 4), and starts energization so as to cause electric current to flow therethrough in the direction from A− to A+ (step S5).

Then, the control circuit 20 determines whether or not the voltage VH2 output from the second magnetic sensor 9 has switched from Hi to Lo (step S7). If the output voltage VH2 has not switched from Hi to Lo (No to the step S7), the control circuit 20 continues to apply the drive voltage to the second coil 5 so as to cause electric current to flow therethrough in the direction from B− to B+ (step S6). Then, the control circuit 20 returns to the step S7.

If the output voltage VH2 has switched from Hi to Lo (YES to the step S7), the control circuit 20 starts to measure the time period (predetermined time period) tb which is to elapse from the switching of the output voltage VH1 to the switching of the output voltage VH2 (=(time period ta which has been measured after the switching of the output voltage VH1 to the present)+(time period which is to elapse after a time point at which the output voltage VH2 switches)) (step S8).

Next, the control circuit 20 determines whether or not the time period ta=the time period tb holds (step S9). If ta=tb does not hold (NO to the step S9), the control circuit 20 waits. If ta=tb holds (YES to the step S9), the control circuit 20 switches the direction of application of the drive voltage VL2 to the second coil 5 (the energization direction of the second coil 5) so as to cause electric current to flow therethrough in a direction from B+ to B− (step S10). Note that the driving control up to the step S 10 is referred to as the first energization driving control.

Then, the control circuit 20 determines whether or not the voltage VH1 output from the first magnetic sensor 8 has switched from Lo to Hi (step S12). If the output voltage VH1 has not switched from Lo to Hi (NO to the step S12), the control circuit 20 continues to apply the drive voltage to the first coil 4 so as to cause electric current to flow therethrough in the direction from A− to A+ (step S11). Then, the control circuit 20 returns to the step S12.

If the output voltage VH1 has switched from Lo to Hi (YES to the step S12), the control circuit 20 starts to measure the time period ta from the switching of the output voltage VH1 to the switching of the output voltage VH2 (step S13). Then, the control circuit 20 determines whether or not ta=tb holds (step S14). If ta=tb does not hold (NO to the step S14), the control circuit 20 waits.

If ta=tb holds (YES to the step S14), the control circuit 20 switches the direction of application of the drive voltage VL1 to the first coil 4 so as to cause electric current to flow therethrough in the direction from A+ to A− (step S15). Note that the driving control from the step S12 up to the step S15 is referred to as the second energization driving control.

Then, the control circuit 20 determines whether or not the voltage VH2 output from the second magnetic sensor 9 has switched from Lo to Hi (step S17). If the output voltage VH2 has not switched from Lo to Hi (NO to the step S17), the control circuit 20 continues to apply the drive voltage to the second coil 5 so as to cause electric current to flow therethrough in the direction from B+ to B− (step S16). Then, the control circuit 20 returns to the step S17.

If the output voltage VH2 has switched from Lo to Hi (YES to the step S17), the control circuit 20 starts to measure the time period ta from the switching of the output voltage VH2 to the switching of the output voltage VH1 (step S18). Then, the control circuit 20 determines whether or not ta=tb holds (step S19). If ta=tb does not hold (NO to the step S19), the control circuit 20 waits.

If ta=tb holds (YES to the step S19), the control circuit 20 switches the direction of application of the drive voltage VL2 to the second coil 5 so as to cause electric current to flow therethrough in the direction from B− to B+ (step S20). Note that the driving control from the step S17 up to the step S20 is referred to as the third energization driving control.

Then, the control circuit 20 determines whether or not the voltage VH1 output from the first magnetic sensor 8 has switched from Hi to Lo (step S22). If the output voltage VH1 has not switched from Hi to Lo (NO to the step S22), the control circuit 20 continues to apply the drive voltage to the first coil 4 so as to cause electric current to flow therethrough in the direction from A+ to A− (step S21). Then, the control circuit 20 returns to the step S22.

If the output voltage VH1 has switched from Hi to Lo (YES to the step S22), the control circuit 20 starts to measure the time period ta from the switching of the output voltage VH1 to the switching of the output voltage VH2 (step S23). Then, the control circuit 20 determines whether or not ta=tb holds (step S24). If ta=tb does not hold (NO to the step S24), the control circuit 20 waits.

If ta=tb holds (YES to the step S24), the control circuit 20 switches the direction of application of the drive voltage VL1 to the first coil 4 so as to cause electric current to flow therethrough in the direction from A− to A+ (step S25). Note that the driving control from the step S22 up to the step S25 is referred to as the fourth energization driving control.

Then, the control circuit 20 determines whether or not the driving rotation amount N has been reached (step S26). If the driving rotation amount N has not been reached (NO to the step S26), the control circuit 20 returns to the step S7 to repeat the driving control described heretofore. On the other hand, if the driving rotation amount N has been reached (YES to the step S26), the control circuit 20 stops the driving control.

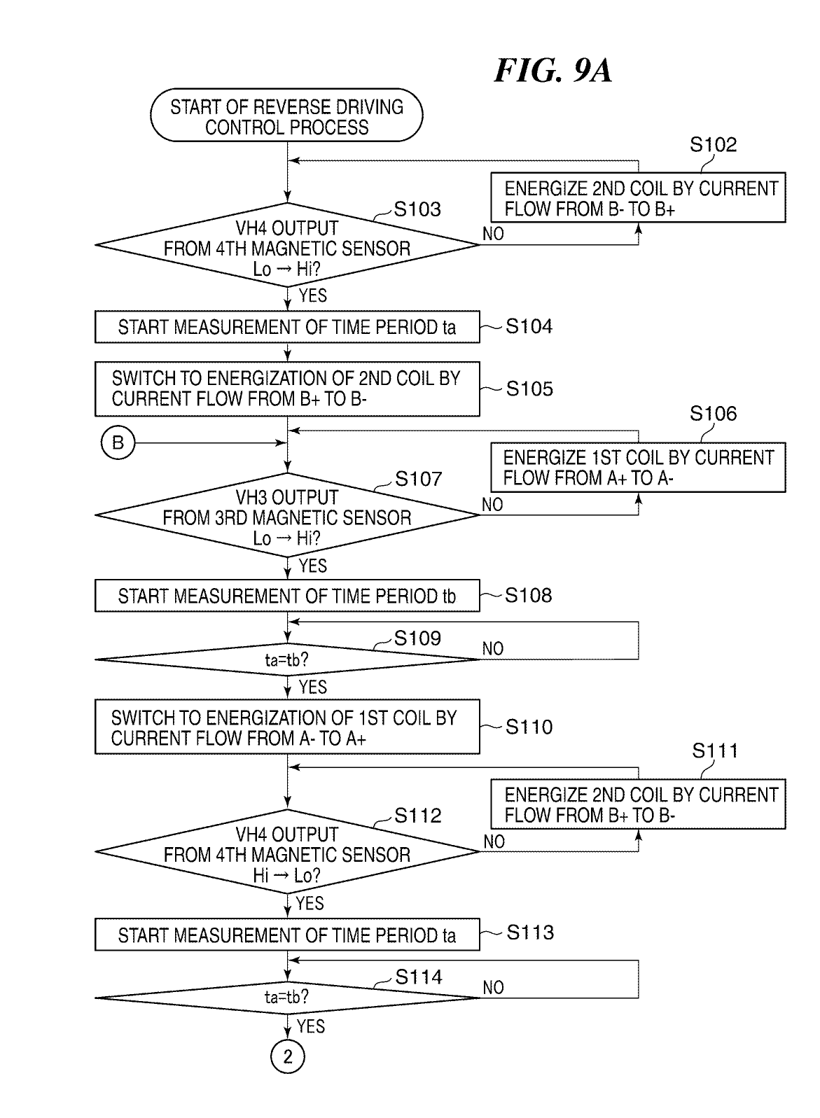

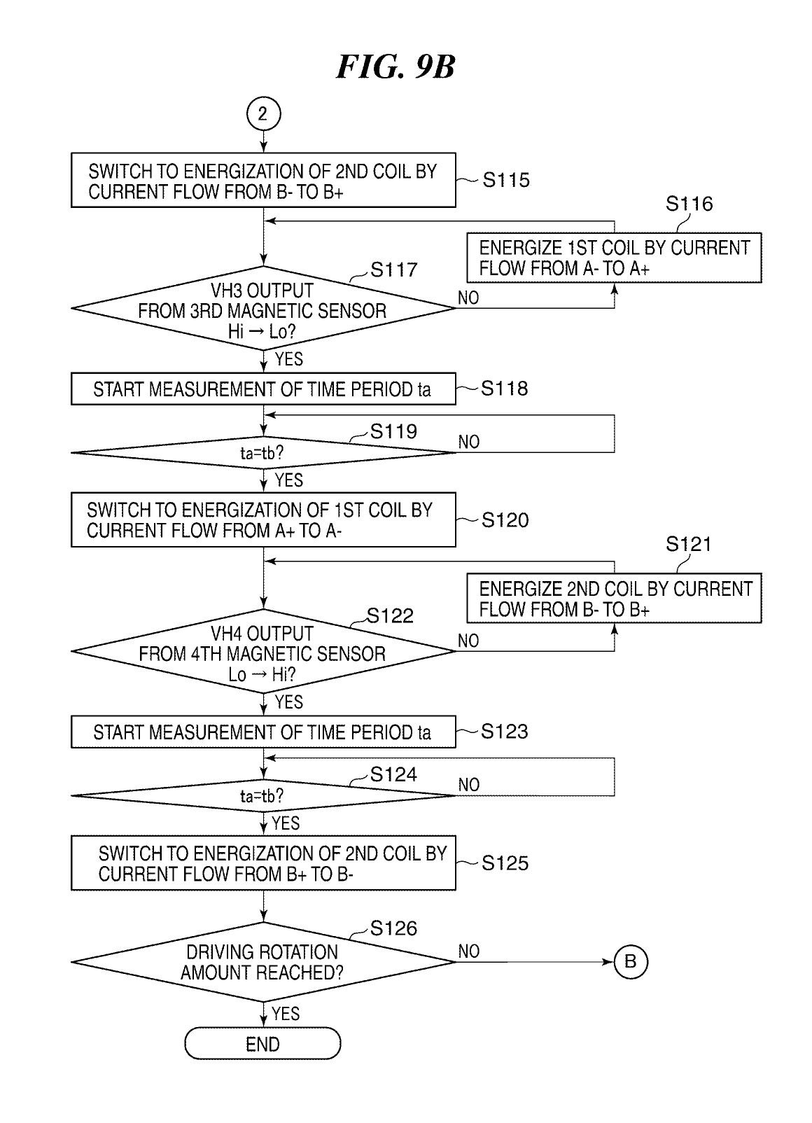

FIGS. 9A and 9B are a flowchart of the motor reverse driving control process performed by the motor drive device shown in FIG. 1.

When the reverse driving control is started, the control circuit 20 determines whether or not the voltage VH4 output from the fourth magnetic sensor 11 has switched from Lo to Hi (step S103). If the output voltage VH4 has not switched from Lo to Hi (NO to the step S103), the control circuit 20 continues to apply the drive voltage to the second coil 5 so as to cause electric current to flow therethrough in the direction from B− to B+ (step S102). Then, the control circuit 20 returns to the step S103.

If the output voltage VH4 has switched from Lo to Hi (YES to the step S103), the control circuit 20 starts to measure the time period ta from the switching of the output voltage VH4 to the switching of the voltage VH3 output from the third magnetic sensor 10 (step S104). Then, the control circuit 20 switches the direction of application of the drive voltage VL2 to the second coil 5 (the energization direction of the second coil 5), and starts energization so as to cause electric current to flow therethrough in the direction from B+ to B− (step S105).

Then, the control circuit 20 determines whether or not the voltage VH3 output from the third magnetic sensor 10 has switched from Lo to Hi (step S107). If the output voltage VH3 has not switched from Lo to Hi (NO to the step S107), the control circuit 20 continues to apply the drive voltage to the first coil 4 so as to cause electric current to flow therethrough in the direction from A+ to A− (step S106). Then, the control circuit 20 returns to the step S107.

If the output voltage VH3 has switched from Lo to Hi (YES to the step S107), the control circuit 20 starts to measure the time period (predetermined time period) tb from the switching of the output voltage VH4 to the switching of the output voltage VH3 (=(time period ta which has been measured after the switching of the output voltage VH4 to the present)+(time period which is to elapse after a time point at which the output voltage VH3 switches)) (step S108).

Then, the control circuit 20 determines whether or not ta=tb holds (step S109). If ta=tb does not hold (NO to the step S109), the control circuit 20 waits. If ta=tb holds (YES to the step S109), the control circuit 20 switches the direction of application of the drive voltage VL1 to the first coil 4 so as to cause electric current to flow therethrough in a direction from A− to A+ (step S110). Note that the driving control from the step S103 up to the step S110 is referred to as the fifth energization driving control.

Then, the control circuit 20 determines whether or not the voltage VH4 output from the fourth magnetic sensor 11 has switched from Hi to Lo (step S112). If the output voltage VH4 has not switched from Hi to Lo (NO to the step S112), the control circuit 20 continues to apply the drive voltage to the second coil 5 so as to cause electric current to flow therethrough in the direction from B+ to B− (step S111). Then, the control circuit 20 returns to the step S112.

If the output voltage VH4 has switched from Hi to Lo (YES to the step S112), the control circuit 20 starts to measure the time period ta from the switching of the output voltage VH4 to the switching of the output voltage VH3 (step S113). Then, the control circuit 20 determines whether or not ta=tb holds (step S114). If ta=tb does not hold (NO to the step S114), the control circuit 20 waits.

If ta=tb holds (YES to the step S114), the control circuit 20 switches the direction of application of the drive voltage VL2 to the second coil 5 so as to cause electric current to flow therethrough in the direction from B− to B+ (step S115). Note that the driving control from the step S112 up to the step S115 is referred to as the sixth energization control.

Then, the control circuit 20 determines whether or not the voltage VH3 output from the third magnetic sensor 10 has switched from Hi to Lo (step S117). If the output voltage VH3 has not switched from Hi to Lo (NO to the step S117), the control circuit 20 continues to apply the drive voltage to the first coil 4 so as to cause electric current to flow therethrough in the direction from A− to A+ (step S116). Then, the control circuit 20 returns to the step S117.

If the output voltage VH3 has switched from Hi to Lo (YES to the step S117), the control circuit 20 starts to measure the time period ta from the switching of the output voltage VH3 to the switching of the output voltage VH4 (step S118). Then, the control circuit 20 compares the time period ta and the time period tb, and determines whether or not ta=tb holds, based on a result of the comparison (step S119). If ta=tb does not hold (NO to the step S119), the control circuit 20 waits.

If ta=tb holds (YES to the step S119), the control circuit 20 switches the direction of application of the drive voltage VL1 to the first coil 4 so as to cause electric current to flow therethrough in the direction from A+ to A− (step S120). Note that the driving control from the step S117 up to the step S120 is referred to as the seventh energization driving control.

Then, the control circuit 20 determines whether or not the voltage VH4 output from the fourth magnetic sensor 11 has switched from Lo to Hi (step S122). If the output voltage VH4 has not switched from Lo to Hi (NO to the step S122), the control circuit 20 continues to apply the drive voltage to the second coil 5 so as to cause electric current to flow therethrough in the direction from B− to B+ (step S121). Then, the control circuit 20 returns to the step S122.

If the output voltage VH4 has switched from Lo to Hi (YES to the step S122), the control circuit 20 starts to measure the time period ta from the switching of the output voltage VH4 to the switching of the output voltage VH3 (step S123). Then, the control circuit 20 determines whether or not ta=tb holds (step S124). If ta=tb does not hold (NO to the step S124), the control circuit 20 waits.

If ta=tb holds (YES to the step S124), the control circuit 20 switches the direction of application of the drive voltage VL2 to the second coil 5 so as to cause electric current to flow therethrough in the direction from B+ to B− (step S125). Note that the driving control from the step S122 up to the step S125 is referred to as the eighth energization driving control.

Then, the control circuit 20 determines whether or not the driving rotation amount N has been reached (step S126). If the driving rotation amount N has not been reached (NO to the step S126), the control circuit 20 returns to the step S107 to repeat the driving control described above. On the other hand, if the driving rotation amount N has been reached (YES to the step S126), the control circuit 20 stops the reverse driving control.

As described above, in the first embodiment of the present invention, the coil energization control is based on a predetermined time period for each moving distance (on a step basis) while detecting the position of the rotor 3. This makes it possible to control rotation of the motor at a constant speed, and reduce rotation fluctuation caused due to load variation. Further, the coil energization direction is switched in synchronism with detection of the position of the rotor 3, and hence it is possible to prevent occurrence of step-out of the stepping motor, which is specific thereto.

Next, a description will be given of a motor drive device according to a second embodiment of the present invention.

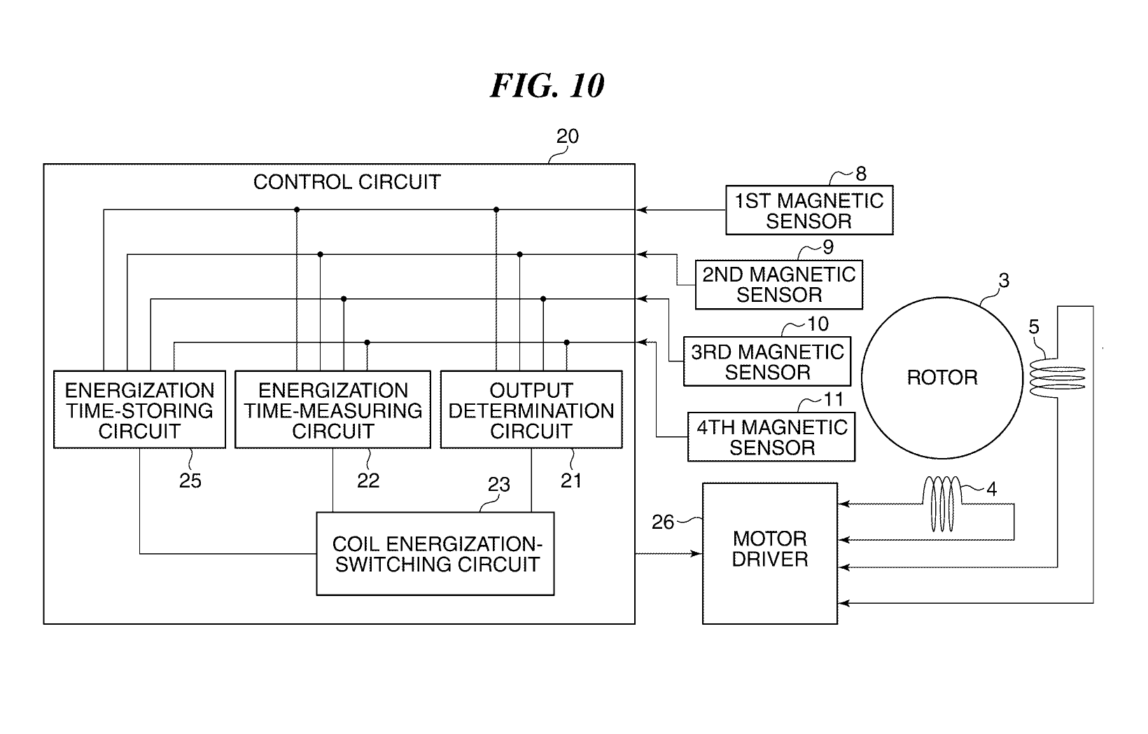

FIG. 10 is a block diagram of the motor drive device according to the second embodiment of the present invention and a motor. The same components in FIG. 10 as those in FIG. 1 are denoted by the same reference numerals, and description thereof is omitted.

In the illustrated motor drive device, the control circuit 20 includes an energization time-storing circuit 25 in place of the energization time-setting circuit 24, and the energization time-storing circuit 25 is connected to the first to fourth magnetic sensors 8 to 11 and the coil energization-switching circuit 23. The energization time-storing circuit 25 stores a time period (elapsed time) taken for an output from each of the first to fourth magnetic sensors 8 to 11 to switch.

For example, the energization time-storing circuit 25 records an energization time period having elapsed after the switching of a voltage output from each of the first to fourth magnetic sensors 8 to 11, and sends the energization time period to the coil energization-switching circuit 23. Note that the energization time-storing circuit 25 updates the energization time period whenever the output voltage switches.

The coil energization-switching circuit 23 receives a result of determination performed by the output determination circuit 21, a time period measured by the energization time-measuring circuit 22, and an energization time period stored in the energization time-storing circuit 25. Then, the coil energization-switching circuit 23 sends switching timing commands for switching drive voltages applied to the first and second coils 4 and 5 to the motor driver 26, based on these received information items.

FIG. 11 is a diagram useful in explaining energization of the first and second coils, performed by the motor drive device shown in FIG. 10.

In the above-described first embodiment, when switching the drive voltage VL1 applied to the first coil 4, a time period to elapse from the switching of the voltage VH1 output from the first magnetic sensor 8 to the switching of the voltage VH2 output from the second magnetic sensor 9 is set as the predetermined time period tb.

On the other hand, in the second embodiment, an energization time period elapsed after switching the coil energization direction is represented by tc (time period stored in the energization time-storing circuit 25), in contrast to the predetermined time period tb. Then, the coil energization-switching circuit 23 compares the time period ta and the energization time period tc. If tc=ta holds, the coil energization-switching circuit 23 switches the coil energization direction. If tc>ta holds, the coil energization-switching circuit 23 turns off coil energization, and if tc<ta holds, the coil energization-switching circuit 23 maintains coil energization.

As shown in FIG. 11, assuming that a time period from the switching of the output voltage VH1 or the output voltage VH2 to the switching of the output voltage VH2 or the output voltage VH1 is represented by ta(n+1) (n is an integer equal to or larger than 1), and the energization time period is represented by tc(n), the coil energization-switching circuit 23 switches the coil energization direction if tc(n)=ta(n+1) holds.

By switching the coil energization direction as described above, it is possible to smoothly switch coil energization depending on the voltage output from each magnetic sensor which has detected each pole of the magnet 2, against load variation of the motor. Further, by smoothly switching the coil energization, it is possible to prevent through current (inrush current) when switching the coil energization, and thereby reduce fluctuation in motor rotational speed.

Here, a description will be given of a case where the motor drive device described in the first or second embodiment is used as a mirror drive device of an image pickup apparatus, such as a digital camera.

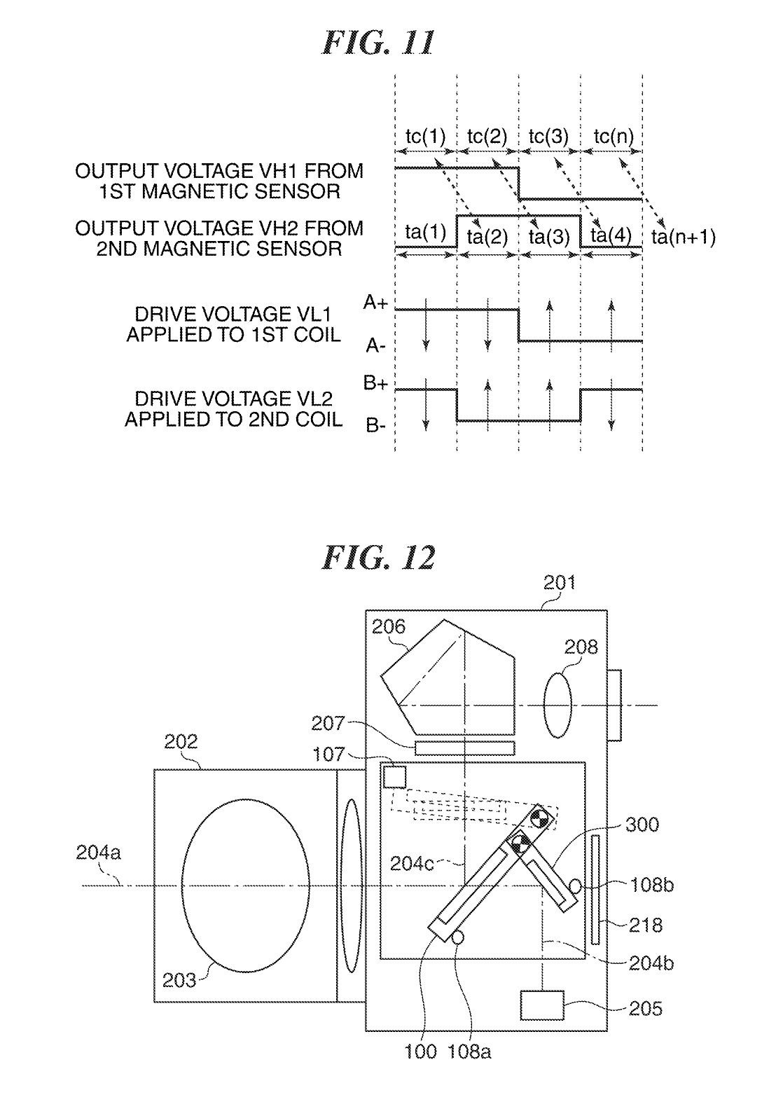

FIG. 12 is a view, partly broken away, of an image pickup apparatus including the motor drive device according to the first or second embodiment.

The illustrated image pickup apparatus is a digital single-lens reflex camera (hereinafter referred to as the camera) 201, and the camera 201 has a photographic lens unit (hereinafter simply referred to as the photographic lens) 202 interchangeably mounted thereon. The photographic lens 202 includes a lens part 203, the lens part 203 is equipped with a focus lens group, not shown, and a zoom lens group, not shown.

The camera 201 has an optical low-pass filter, not shown, an infrared cut filter, not shown, and an image pickup device 218, arranged in the vicinity of a predetermined image forming plane on which an optical image entering through the photographic lens 202 is formed. The image pickup device 218 is implemented e.g. by a CMOS sensor. A main mirror (moving member) 100 is arranged between the photographic lens 202 and the image pickup device 218 in a manner inclined with respect to a photographing optical path 204a on the optical axis.

The main minor 100 can be driven to move between a minor-up position and a minor-down position, described hereinafter, and when the main mirror 100 is in the minor-down position, the main minor 100 reflects an optical image having passed through the photographic lens 202 to thereby guide the same toward a focus detection plate 207 though an optical path 204c, and also allows the optical image to pass therethrough. A sub minor 300 is arranged at a rear stage of the main mirror 100, and when the sub mirror 300 is in a mirror-down position, the sub mirror 300 reflects the optical image having passed through the main minor 100, and guides the reflected optical image toward a focus detection unit 205 through an optical path 204b. Note that rotation of the sub mirror 300 is restricted by a stopper 108b.

When the main mirror 100 and the sub mirror are in the minor-up position, the optical image is formed on the image pickup device 218 through the photographic lens 202. Then, the image pickup device 218 outputs image signals according to the optical image.

The focus detection plate 207 is disposed at a position which is equivalent to the position of the image-forming plane of the image pickup device 218 with respect to the photographic lens 202. The optical image reflected by the main mirror 100 is primarily formed on the focus detection plate 207. A photographer can observe this optical image via an eyepiece lens 208 and a pentaprism 206.

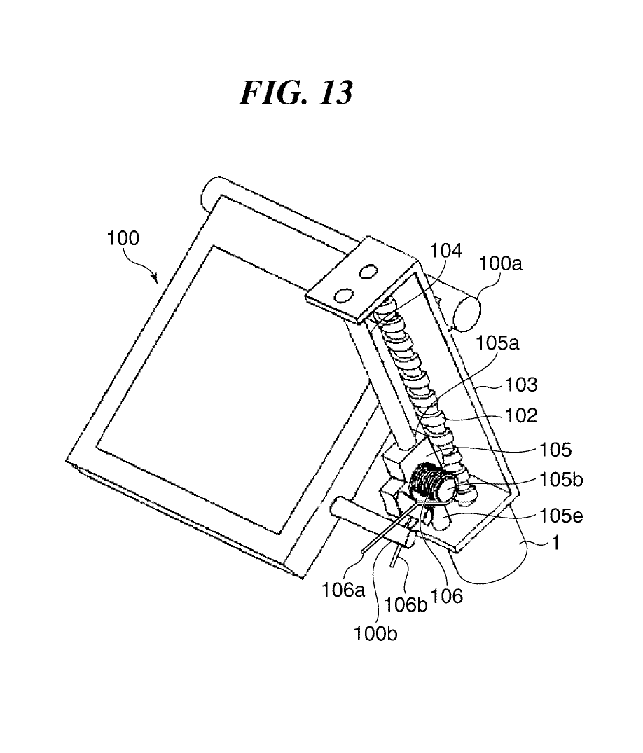

FIG. 13 is a perspective view of an example of the mirror drive device used in the camera shown in FIG. 12.

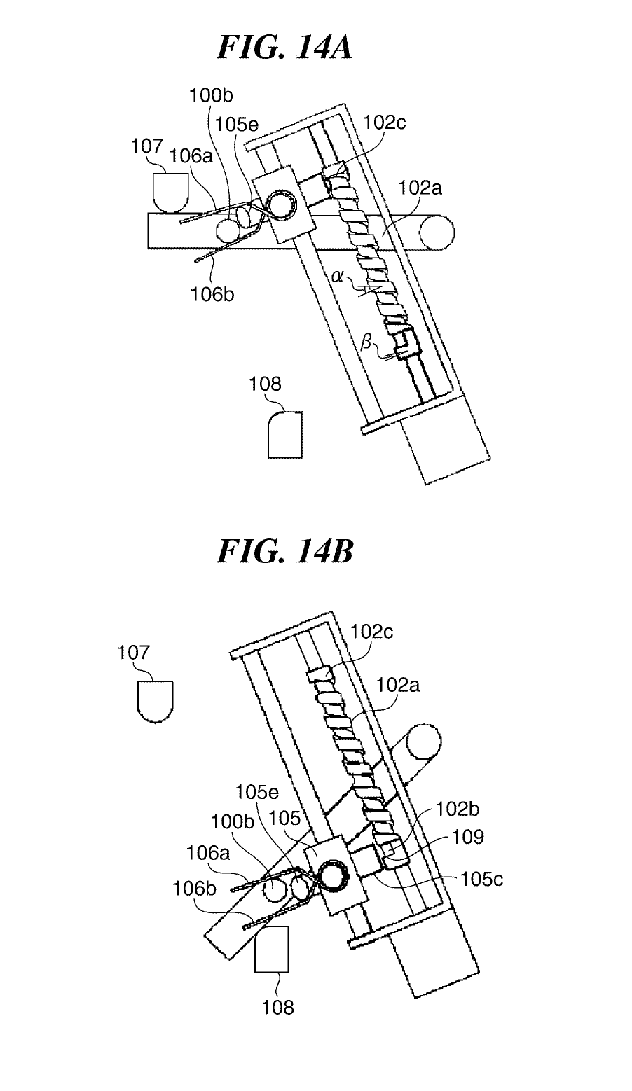

Further, FIGS. 14A and 14B are side views of the mirror drive device used in the camera shown in FIG. 12. FIG. 14A is a side view of the mirror drive device in a state in which the main minor is in the minor-up position, and FIG. 14B is a side view of the same in a state in which the main minor is in the mirror-down position.

Note that the mirror-up position is a position where the main mirror 100 is retracted from the photographing optical path 204a, and extends in parallel with the photographing optical path 204a. Further, the mirror-down position is a position where the main mirror 100 enters the photographing optical path 204a, and is inclined at an angle of 45 degrees with respect to the photographing optical path 204a.

The main mirror 100 is rotatable between the mirror-up position and the mirror-down position, about a rotating shaft 100a.

The motor (stepping motor) 1 is controlled to be driven for rotation in the two directions of the normal rotational direction and the reverse rotational direction by the above-described motor drive device. A lead screw 102 is integrally fixed to an output shaft of the motor 1, and is driven for rotation in accordance with rotation of the motor 1.

A motor frame 103 holds the motor 1, the lead screw 102, and a guide bar 104, and is fixed to the camera 201. A driving rack 105 is formed with a guide hole 105a, and is movably fitted on the guide bar 104 which extends through the guide hole 105a, whereby the driving rack 105 can be moved in parallel with the lead screw 102. The driving rack 105 further includes a protruding portion 105c which protrudes toward the lead screw 102, and a first ball 109 formed on the protruding portion 105c.

A torsion spring 106 is fitted on a shaft portion 105b of the driving rack 105 and held thereon. Arm portions 106a and 106b of the torsion spring 106 hold a driving dowel 100 of the main mirror 100 and a driving dowel 105e of the driving rack 105 therebetween. With this arrangement, the driving rack 105 and the main mirror 100 are connected to each other with resilience.

A first stopper 107 restricts rotation of the main mirror 100 at the minor-up position, and a second stopper 108 (denoted by reference numeral 108a in FIG. 12) restricts rotation of the main minor 100 at the minor-down position.

First, a description will be given of the operation of the minor drive device for driving the main minor 100 when it is moved from the mirror-down position shown in FIG. 14B to the mirror-up position shown in FIG. 14A.

When the main mirror 100 is in the minor-down position, the first ball 109 on the protruding portion 10c of the driving rack 105 is engaged with a second lead groove 102b of the lead screw 102. Further, the arm portion 106a of the torsion spring 106 is in contact with the driving dowel 100b of the main minor 100, and the arm portion 106b is in contact with the driving dowel 105e of the driving rack 105. In this state, the main minor 100 is pressed against the second stopper 108 by the arm portion 106a of the torsion spring 106, whereby the position of the main minor 100 is restricted.

When the motor 1 is driven to rotate the lead screw 102 from the above-mentioned state, the driving rack 105 starts to be moved along the second lead groove 102b in accordance with a lead angle thereof. The main minor 100 starts to be rotated in the clockwise direction in FIG. 14B in accordance with the movement of the driving rack 105, whereby the main mirror 100 is released from the state pressed against the second stopper 108.

As the motor 1 is further driven to rotate the lead screw 102, the first ball 109 is engaged with a first lead groove 102a having a large lead angle. At this time, the driving rack 105 is quickly driven along the first lead groove 102a in accordance with the large lead angle thereof

Before the main minor 100 reaches the minor-up position, the first ball 109 is engaged with a third lead groove 102c having a small lead angle. The driving rack 105 is moved in this state to cause the main minor 100 to reach the minor-up position. At this time, as shown in FIG. 14A, the ann portion 106a of the torsion spring 106 is in contact with the driving dowel 105e of the driving rack 105, and the arm portion 106b is in contact with the driving dowel 100b of the main minor 100.

The main minor 100 is pressed against the first stopper 107 by the arm portion 106b of the torsion spring 106, whereby the position of the main mirror 100 is restricted.

When the main mirror 100 is in the mirror-down position or the minor-up position, the first ball 109 is engaged with the second lead groove 102b or the third lead groove 102c. The second lead groove 102b and the third lead groove 102c are smaller in lead angle than the first lead groove 102a. Therefore, even if an impact force is applied to the main mirror 100, the force for rotating the lead screw 102 via the driving rack 105 is very small. Further, even if the driving rack 105 receives an impact force in a direction of releasing the charging force of the torsion spring 106 from the main mirror 100, since the lead angle of the lead screw 102 is small, the force for rotating the motor 101 is very small.

Therefore, it is possible to hold the main mirror 100 in the mirror-up position or the mirror-down position only with a holding torque at the time of non-energization of the motor 1.

Further, when the main mirror 100 is being moved between the mirror-down position and the mirror-up position, the first ball 109 is engaged with the first lead groove 102a having the large lead angle. Therefore, the driving rack 105 can be quickly moved even though the amount of one rotation of the motor 1 is small.

Next, a description will be given of the operation of the mirror drive device for driving the main minor 100 when it is moved from the mirror-up position shown in FIG. 14A to the minor-down position shown in FIG. 14B.

When the motor 1 is driven in a reverse direction to rotate the lead screw 102, the driving rack 105 starts to be moved along the third lead groove 102c in accordance with the lead angle thereof. As the driving rack 105 is moved, the main mirror 100 starts to be rotated in the counterclockwise direction as viewed in FIG. 14A, whereby the main mirror 100 is released from the state pressed against the first stopper 107.

As the motor 1 is further driven in the reverse direction to rotate the lead screw 102, the first ball 109 is engaged with the first lead groove 102a. At this time, the driving rack 105 is quickly driven along the first lead groove 102a in accordance with the large lead angle thereof.

Before the main mirror 100 reaches the mirror-down position, the first ball 109 is engaged with the second lead groove 102b which is smaller in lead angle than the first lead groove 102a. The driving rack 105 is moved in this state to cause the main mirror 100 to reach the mirror-down position. At this time, as shown in FIG. 14B, the arm portion 106a of the torsion spring 106 is in contact with the driving dowel 100b of the main mirror 100, and the arm portion 106b is in contact with the driving dowel 105e of the driving rack 105. The main mirror 100 is pressed against the second stopper 108 by the arm portion 106a of the torsion spring 106, whereby the position of the main minor 100 is restricted.

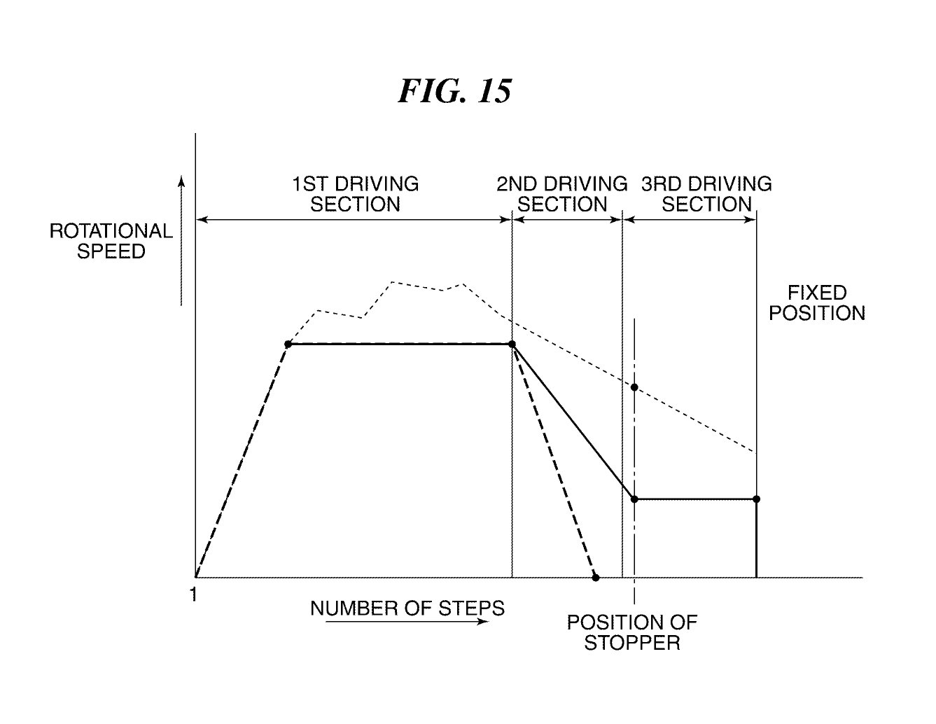

FIG. 15 is a diagram showing an example of a relationship between a motor rotational speed and mirror driving sections of the mirror drive device shown in FIG. 13.

Referring to FIG. 15, the range of driving of the main mirror 100 from a horizontal posture position where it starts to be rotated, shown in FIG. 14A, to an inclined posture position where it is stopped and is inclined at a angle of 45 degrees with respect to the photographing optical path, shown in FIG. 14B, is divided into three driving sections (mirror driving sections). A solid line in FIG. 15 indicates a relationship between the number of steps and the rotational speed in a case where the speed of the motor 1 is controlled, and a broken line indicates a relationship between the number of steps and the rotational speed in a case where the speed of the motor 1 is not controlled.

The first driving section is a driving range of the motor 1 in which the main mirror 100 is moved from a stationary state to a position before being brought into abutment with the stopper 107. The second driving section is a driving range of the motor 1 in which the main mirror 100 is moved from the position before being brought into abutment with the stopper 107 to a position where it is brought into abutment with the stopper 107. The third driving section is a driving range of the motor 1 after the main mirror 100 is brought into abutment with the stopper 107 until the main mirror 100 is stopped at a fixed position.

In the first driving section, the driving control of the motor 1 is performed by switching the drive voltage applied to the first coil 4 or the second coil 5, according to the switching of the output voltage from an associated one of the magnetic sensors, occurring when the associated magnetic sensor detects a change in the magnetic pole of the magnet 2 of the rotor 3.

Here, in the first driving this section, the mirror drive device as the motor drive device according to the first embodiment controls the speed of the motor 1 based on the predetermined time period tb set in advance for energization. When it is desired to quickly start the motor 1, the energization time-measuring circuit 22 included in the mirror drive device is turned off, and the steps S4, S9, S14, and S19 in FIGS. 8A and 8B are omitted.

In the second driving section, it is desirable to perform deceleration driving of the motor 1 using the predetermined time period tb set in advance for energization. When it is desired to perform rapid deceleration, the energization time-measuring circuit 22 included in the mirror drive device is turned off, and the steps S4, S9, S14, and S19 in FIGS. 8A and 8B are omitted.

In the third driving section, the driving control of the motor 1 is performed by switching the drive voltage applied to the first coil 4 or the second coil 5 according to the switching of the output voltage from an associated one of the magnetic sensors, occurring when the associated magnetic sensor detects a change in the magnetic pole of the magnet 2 of the rotor 3. Further, based on the output voltages from the two magnetic sensors, the drive voltages applied to the first coil 4 and the second coil 5 are each sequentially switched, on condition that the predetermined time period tb set in advance and the measured time period ta become equal to each other. This makes it possible to control the motor at a constant speed without causing step-out of the motor 1 even when the load on the motor is increased by load variation on the minor caused due to the posture position of the mirror drive device and the temperature environment.

From the above, it is possible to provide the motor drive device that makes it possible to stop the mirror at a fixed position while reducing mirror collision noise, by controlling the speed of rotation of the mirror such that the speed of rotation is reduced until the mirror rotates to the position before the stopper, and then the mirror is brought into abutment with the stopper by the low-speed control.

Note that the driving control in the third driving section may be performed by the mirror drive device as the motor drive device according to the second embodiment, as described above, such that when tc=ta holds, the coil energization direction is switched, when tc>ta holds, the coil energization is turned off, and when tc<ta holds, the coil energization direction is maintained.

Here, a description will be given of another example of the driving control performed by the motor drive device shown in FIGS. 1.

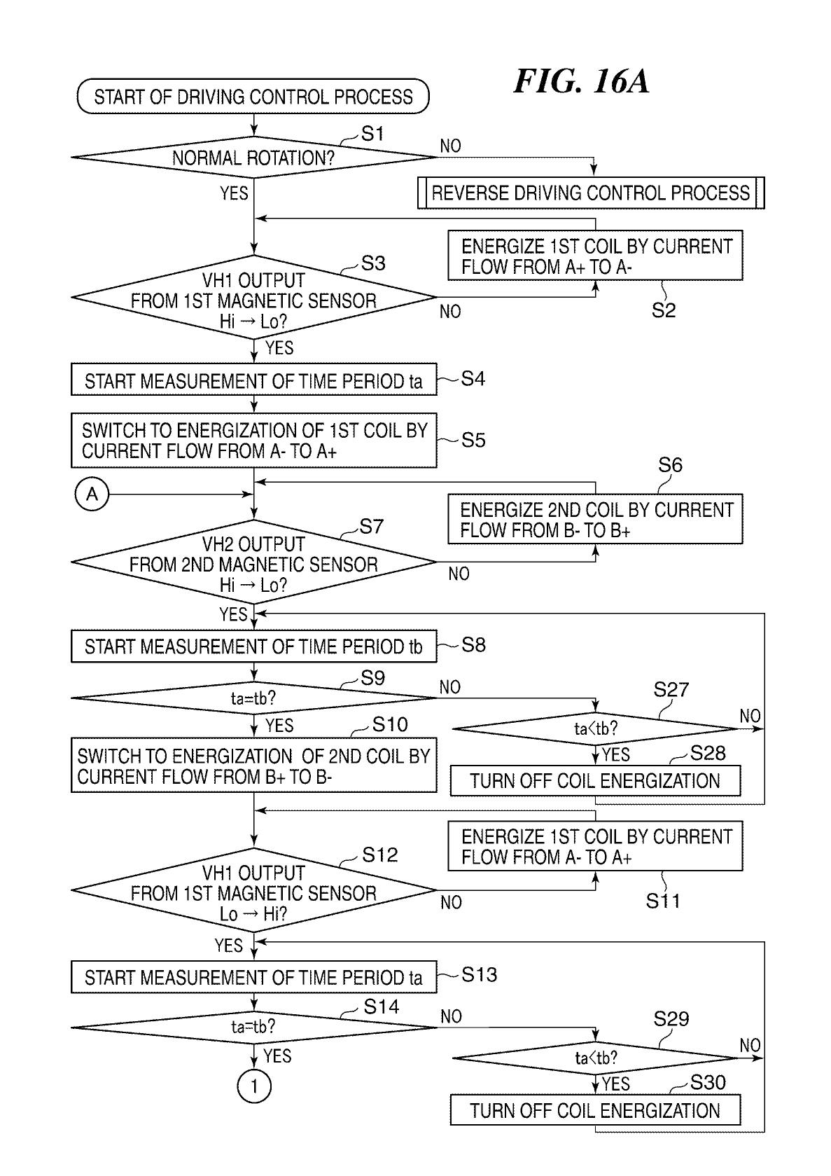

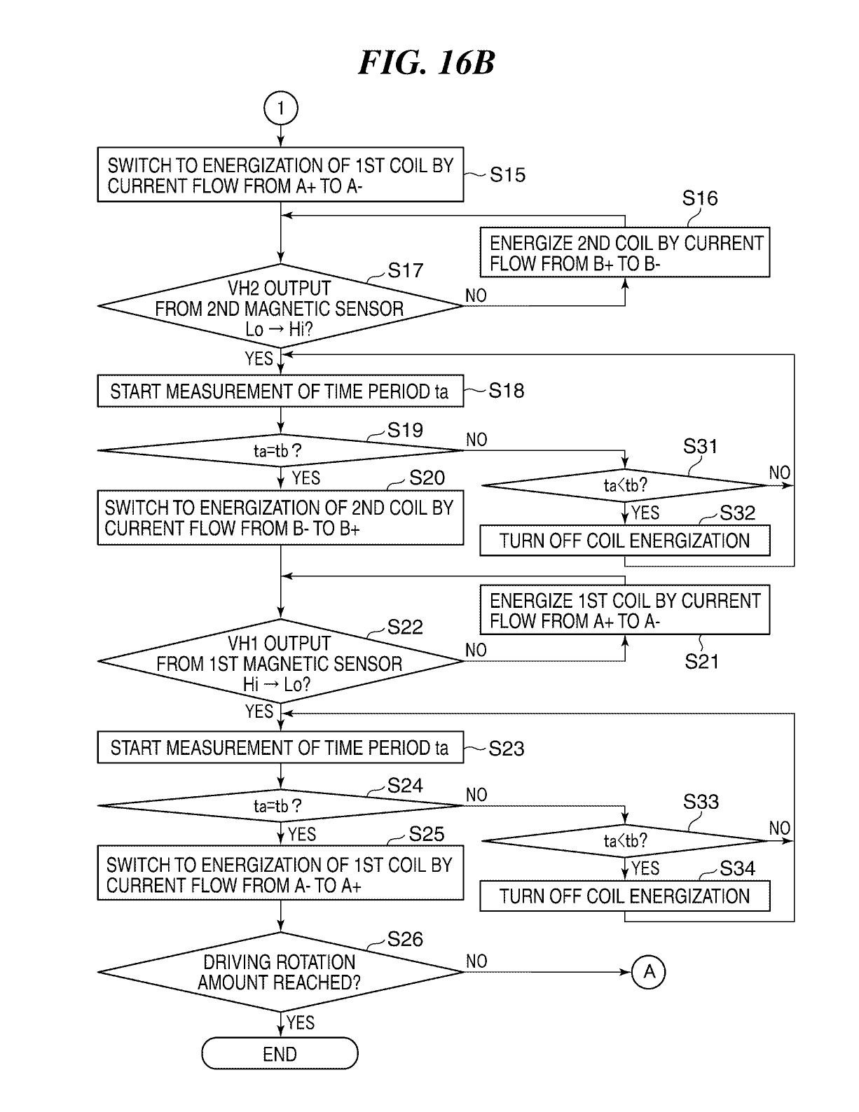

FIGS. 16A and 16B are a flowchart of a variation of the motor driving control process performed by the motor drive device shown in FIG. 1. Note that the same steps in FIGS. 16A and 16B as those in FIGS. 8A and 8B are denoted by the same step numbers, and description thereof is omitted.

If it is determined in the step S9 that ta=tb does not hold, the control circuit 20 determines whether or not ta<tb holds (step S27).

If ta<tb holds (YES to the step S27), the control circuit 20 turns off the coil energization (step S28). Then, the control circuit 20 returns to the step S8.

On the other hand, if ta>tb holds (NO to the step S27), the control circuit 20 returns to the step S8. That is, the control circuit 20 maintains the coil energization.

If it is determined in the step S14 that ta=tb does not hold, the control circuit 20 determines whether or not ta<tb holds (step S29). If ta<tb holds (YES to the step S29), the control circuit 20 turns off the coil energization (step S30). Then, the control circuit 20 returns to the step S13.

On the other hand, if ta>tb holds (NO to the step S29), the control circuit 20 returns to the step S13.

If it is determined in the step S19 that ta=tb does not hold, the control circuit 20 determines whether or not ta<tb holds (step S31). If ta<tb holds (YES to the step S31), the control circuit 20 turns off the coil energization (step S32). Then, the control circuit 20 returns to the step S18.

On the other hand, if ta>tb holds (NO to the step S31), the control circuit 20 returns to the step S18.

If it is determined in the step S24 that ta=tb does not hold, the control circuit 20 determines whether or not ta<tb holds (step S33). If ta<tb holds (YES to the step S33), the control circuit 20 turns off the coil energization (step S34). Then, the control circuit 20 returns to the step S23.

On the other hand, if ta>tb holds (NO to the step S33), the control circuit 20 returns to the step S23.

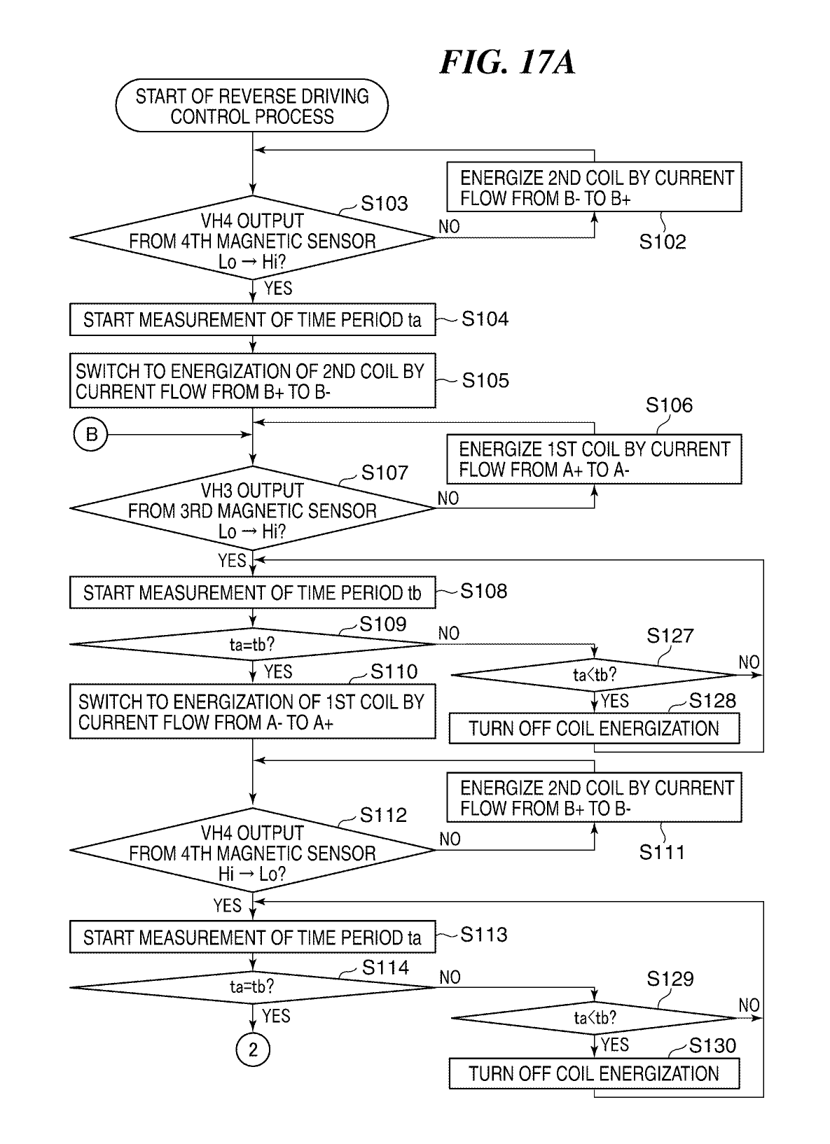

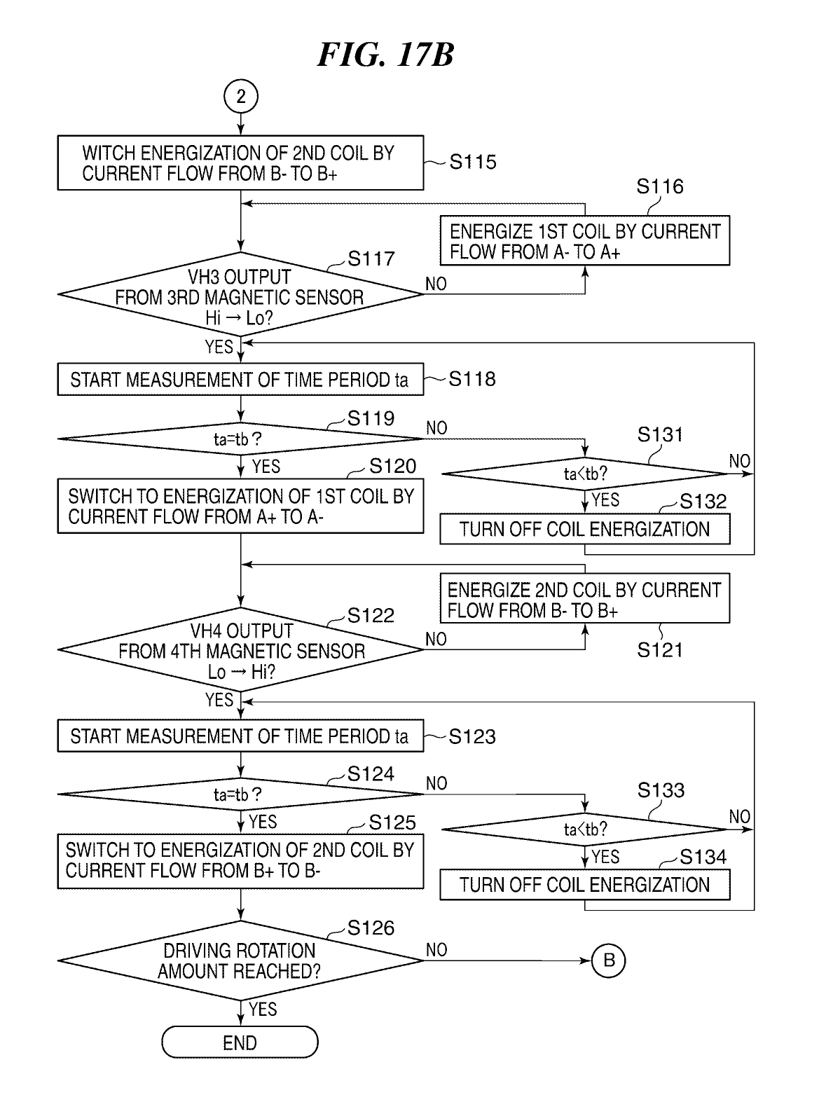

FIGS. 17A and 17B are a flowchart of a variation of the motor reverse driving control process performed by the motor drive device shown in FIG. 1. Note that the same steps in FIGS. 17A and 17B as those in FIGS. 9A and 9B are denoted by the same step numbers, and description thereof is omitted.

If it is determined in the step S109 that ta=tb does not hold, the control circuit 20 determines whether or not ta<tb holds (step S127).

If ta<tb holds (YES to the step S127), the control circuit 20 turns off the coil energization (step S128). Then, the control circuit 20 returns to the step S108.

On the other hand, if ta>tb holds (NO to the step S127), the control circuit 20 returns to the step S108. That is, the control circuit 20 maintains the coil energization.

If it is determined in the step S114 that ta=tb does not hold, the control circuit 20 determines whether or not ta<tb holds (step S129). If ta<tb holds (YES to the step S129), the control circuit 20 turns off the coil energization (step S130). Then, the control circuit 20 returns to the step S113.

On the other hand, if ta>tb holds (NO to the step S129), the control circuit 20 returns to the step S113.

If it is determined in the step S119 that ta=tb does not hold, the control circuit 20 determines whether or not ta<tb holds (step S131). If ta<tb holds (YES to the step S131), the control circuit 20 turns off the coil energization (step S132). Then, the control circuit 20 returns to the step S118.

On the other hand, if ta>tb holds (NO to the step S131), the control circuit 20 returns to the step S118.

If it is determined in the step S124 that ta=tb does not hold, the control circuit 20 determines whether or not ta<tb holds (step S133). If ta<tb holds (YES to the step S133), the control circuit 20 turns off the coil energization (step S134). Then, the control circuit 20 returns to the step S123.

On the other hand, if ta>tb holds (NO to the step S133), the control circuit 20 returns to the step S123.

Here, a description will be given of another example of the driving control performed by the mirror drive device, shown in FIG. 13.

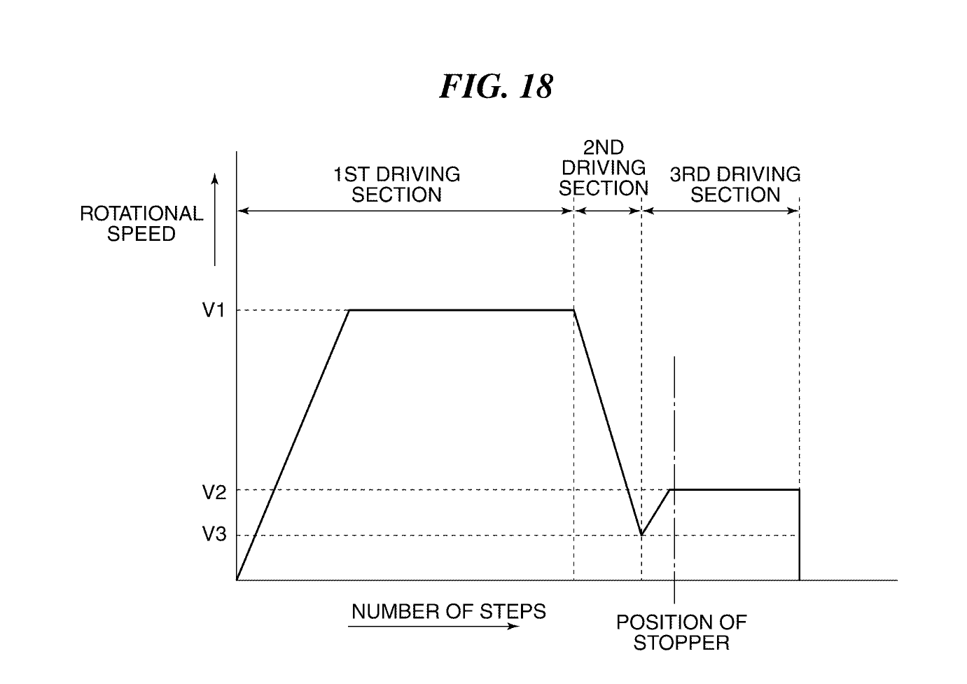

FIG. 18 is a diagram showing another example of the relationship between the motor rotational speed and the minor driving sections of the minor drive device shown in FIG. 13. Note that in FIG. 18, the main minor 100 rotates from the horizontal posture position, and stops at the inclined posture position at an angle of 45 degrees with respect to the photographing optical path.

The first driving section is a driving range of the motor 1 in which the acceleration driving of the motor 1 is started, and then the rotational speed of motor 1 is maintained at V1 until the deceleration driving of the same is started. The second driving section is a driving range of the motor 1 in which the deceleration driving of the motor 1 is started, and continues until the rotational speed of the motor 1 reaches V3. The third driving section is a driving range of the motor 1 in which the rotational speed of the motor 1 becomes equal to V2, and then the main minor 100 is driven at the fixed speed until it is brought into abutment with the stopper 107 and stopped at the fixed position. Here, V2 V3 holds. That is, the rotational speed V2 is not lower than the predetermined rotational speed.

In the first driving section, after increasing the rotational speed of the motor 1, the motor 1 is driven at a constant speed. In this section, the driving control of the motor 1 is performed by switching the drive voltage applied to the first coil 4 or the second coil 5, according to the switching of the output voltage from an associated one of the magnetic sensors, occurring when the magnetic sensor detects a change in the magnetic pole of the magnet 2 of the rotor 3.

Here, since the main mirror 100 is in the stopped state at the start of driving the motor 1, acceleration driving of the motor 1 is performed. After that, the mirror drive device compares the measured time period ta obtained by the energization time-measuring circuit 22 and the predetermined time period tb (rotational speed=V1) set in advance for energization, and performs the driving control for switching the drive voltage depending on a result of the comparison to thereby drive the motor 1 at a constant speed.

This makes it possible to prevent load variation on the main mirror 100 due to the posture position of the main mirror 100 and the temperature environment, and thereby stably drive the main mirror 100.

In the second driving section, deceleration driving of the motor 1 is performed by the brake control. In this section, in a case where the driving is in the first energization mode in which the rotor 3 is rotated in the clockwise direction (performs normal rotation), the energization mode is changed to the second energization mode in which the rotor 3 is rotated in the counterclockwise direction (performs reverse rotation). This brake control is referred to as the reverse energization control. The brake control is not limited to the reverse energization control, but the brake control may be performed by reducing the drive voltages applied to the first coil 4 and the second coil 5. In a case where the voltage is digitally controlled, the duty ratio may be reduced.

Here, when deceleration driving of the motor 1 is performed by the brake control using the reverse energization control, the rotational speed of the motor 1 is monitored according to the measured time period ta. Then, the rotational speed of the motor 1 is reduced to V3 which is not higher than the rotational speed V2 at which the main mirror 100 is brought into abutment with the stopper 107 in the third driving section.

Assuming that the rotational speed of the motor 1 is adjusted to V2 so as to bring the main mirror 100 into abutment with the stopper 107, if the current rotational speed is larger than V2 (ta<tb), it is necessary to perform deceleration driving from the current rotational speed. Here, even after the brake control, if the rotational speed of the motor 1 is still larger than V2 (ta<tb), the deceleration driving control for turning off the coil energization is performed as described above. In a case where the deceleration driving control is performed, the reverse energization control can more quickly reduce the rotational speed than the driving control of turning off the coil energization.

In the third driving section, in a case where the rotational speed of the motor 1 is controlled to V3 which is lower than V2 by the above-described brake control, acceleration driving is performed. After that, the motor drive device compares the measured time period ta obtained by the energization time-measuring circuit 22 and the predetermined time period tb (rotational speed=V2) set in advance for energization, and performs the driving control for switching the drive voltage depending on a result of the comparison to thereby drive the motor 1 at a constant speed.

Note that in a case where the rotational speed of the motor 1 is controlled to V2≅V3 by the above-mentioned brake control, the motor 1 is driven at a constant speed.

As described above, the constant-speed driving is performed immediately before the main mirror 100 is brought into abutment with the stopper 107. With this driving, even when the load on the motor is increased by load variation on the mirror due to the posture position of the main mirror and the temperature environment, it is possible to control the motor at a constant speed without causing step-out of the motor 1.

Note that the driving of the motor 1 by switching the drive voltage applied to the first coil 4 or the second coil 5, according to the switching of the output voltage from an associated one of the magnetic sensors, occurring when the associated magnetic sensor detects a change in the magnetic pole of the magnet 2 of the rotor 3 is referred to as the first driving mode. Further, the above-described deceleration driving is referred to as the second driving mode. Furthermore, the driving for switching the drive voltage applied to the coil when the predetermined time period tb set in advance for energization is equal to the measured time period ta, based on output voltages from the two magnetic sensors, is referred to as the third driving mode. The control circuit 20 selectively performs the first driving mode, the second driving mode, and the third driving mode.

As described above, according to the embodiments of the present invention, it is possible to smoothly switch the coil energization. As a result, rotation fluctuation of the motor is reduced without generating through current when switching the coil energization.

Although in the above-described embodiments, the description is given of the mirror drive device used for a single-lens reflex digital camera, by way of example, the present invention can also be applied to a drive mechanism which requires not only quickly driving a driven member but also reducing collision impact at a final stopped position.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-155773 filed Aug. 10, 2017 which is hereby incorporated by reference herein in its entirety.

What is claimed is:

1. A motor drive device that controls driving of a motor including a detection sensor for detecting a rotational position of a rotor, comprising:
one or more processors, wherein the processor functions as the following units according to a program stored in a memory:
a setting unit configured to set an energization time period of the motor; and
a control unit configured to control driving of the motor, depending on a detection result output from the detection sensor and the energization time period set by the setting unit.

2. The motor drive device according to claim 1, wherein the motor includes a first stator and a second stator,
wherein an output voltage from the detection sensor switches depending on a rotational position of the rotor, and
wherein the control unit measures a time period which elapses until the output voltage from the detection sensor switches as a measured time period, and switches energization of the first stator and the second stator depending on a result of comparison between the measured time period and the set energization time period.

3. The motor drive device according to claim 2, wherein the control unit switches directions of electric currents flowing through respective coils included in the first stator and the second stator.

4. The motor drive device according to claim 3, wherein in a case where the measured time period and the set energization time period are equal to each other, the control unit switches the directions of electric currents flowing through the coils.

5. The motor drive device according to claim 3, wherein in a case where the measured time period is shorter than the set energization time period, the control unit turns off energization of the coils.

6. The motor drive device according to claim 3, wherein in a case where the measured time period is longer than the set energization time period, the control unit does not switch the directions of electric currents flowing through the coils.

7. The motor drive device according to claim 2, wherein the control unit sets a time period which is to elapse after switching of the energization is performed until the voltage output from the detection sensor switches, as the set energization time period.

8. The motor drive device according to claim 1, wherein the motor drives a moving member which can be moved between a first position and a second position.

9. The motor drive device according to claim 2, wherein the control unit selectively performs a first driving mode for driving the motor by switching the energization depending on the output voltage from the detection sensor, a second driving mode for performing deceleration driving of the motor, and a third driving mode for driving the motor by switching the energization depending on a result of the comparison.

10. The motor drive device according to claim 8, wherein when driving the moving member which can be moved between the first position and the second position, a section from the start of movement of the moving member to the stop of the same is divided into a first driving section, a second driving section, and a third driving section, and
wherein the control unit drives the motor, when in the first driving section, in the first driving mode, when in the second driving section, in the second driving mode such that a rotational speed of the motor is controlled to a predetermined rotational speed, and when in the third driving section, in the third driving mode such that the rotational speed of the motor is controlled to a rotational speed not lower than the predetermined rotational speed.

11. The motor drive device according to claim 8, wherein the moving member is a mirror that is provided in an image pickup apparatus, for guiding an optical image having passed through a photographic lens to an image pickup device when the mirror is in the first position, and reflecting the optical image when the mirror is in the second position.

12. A method of controlling a motor drive device that controls driving of a motor including a detection sensor for detecting a rotational position of a rotor, comprising:
setting an energization time period of the motor; and
controlling driving of the motor, depending on a detection result output from the detection sensor and the set energization time period.

13. A non-transitory computer-readable storage medium storing a computer-executable program for executing a method of controlling a motor drive device that controls driving of a motor including a detection sensor for detecting a rotational position of a rotor,
wherein the method comprises:
setting an energization time period of the motor; and
controlling driving of the motor, depending on a detection result output from the detection sensor and the set energization time period.
